(19) United States
(12) Patent Application Publication
(10) Pub. No.: US 2024/0178554 A1
(43) Pub. Date: May 30, 2024

(54) VEHICULAR ANTENNA DEVICE

(71) Applicant: YOKOWO CO., LTD., Chiyoda-ku, Tokyo (JP)

(72) Inventors: Bunpei HARA, Tomioka-Shi, Gunma (JP); Seiya HIROKI, Tomioka-Shi, Gunma (JP)

(73) Assignee: YOKOWO CO., LTD., Chiyoda-ku, Tokyo (JP)

(21) Appl. No.: 18/284,564

(22) PCT Filed: Mar. 29, 2022
(86) PCT No.: PCT/JP2022/015403

§ 371 Date: Sep. 28, 2023

Related U.S. Application Data
(60) Provisional application No. 63/170,043, filed on Apr. 2, 2021.

(30) Foreign Application Priority Data
Mar. 29, 2021 (JP) 2021-055543
Aug. 2, 2021 (JP) 2021-126567

(51) Int. Cl. H01Q 1/32; H01Q 1/42; H01Q 21/06

(52) U.S. Cl. CPC H01Q 1/32; H01Q 1/42; H01Q 21/06

(57) ABSTRACT

A vehicular antenna device includes: a base; a case forming an accommodation space, with the base; and a first antenna accommodated in the accommodation space, the first antenna supporting radio waves in a desired frequency band, wherein at least a portion of the first antenna is arranged at a proximate position close to the case.

### TECHNICAL FIELD

The present disclosure relates to a vehicular antenna device.

### BACKGROUND ART

In recent years, vehicular antenna devices including antennas that support vehicle to everything (V2X: vehicle-to-vehicle communication, road-to-vehicle communication) have been developed (for example, Patent Literature 1).

### CITATION LIST

### Patent Literature

[PTL 1] Japanese Unexamined Patent Application Publication No. 2020-198593

### SUMMARY OF INVENTION

### Technical Problem

In an antenna device disclosed in Patent Literature 1, the V2X antenna is arranged at a predetermined position in the rear of the antenna device. In such a case, the forward gain of the V2X antenna may significantly decreases as compared to the rearward gain thereof. Accordingly, the directivity of the antenna in Patent Literature 1 deteriorates, and the antenna device cannot appropriately support radio waves in a desired frequency band.

The present disclosure is directed to provision of a vehicular antenna device capable of appropriately supporting radio waves in a desired frequency band. The present disclosure is also directed to others which will become apparent from the description of the present specification.

### Solution to Problem

An aspect of the present disclosure is a vehicular antenna device comprising: a base; a case forming an accommodation space, with the base; and a first antenna accommodated in the accommodation space, the first antenna supporting radio waves in a desired frequency band, wherein at least a portion of the first antenna is arranged at a proximate position close to the case.

### Advantageous Effects of Invention

According to an aspect of the present disclosure, it is possible to provide a vehicular antenna device capable of appropriately supporting radio waves in the desired frequency band.

### BRIEF DESCRIPTION OF DRAWINGS

FIG. 1 is a perspective view of a vehicular antenna device 10.

FIG. 2A is a diagram illustrating an example of a case 300 and a ground plate 320. FIG. 2B is a diagram for explaining the position of an antenna 310 in the case 300.

FIG. 3 is a diagram illustrating the horizontal directivity at a distance Da=20 mm.

FIG. 4 is a diagram illustrating the horizontal directivity at a distance Da=50 mm.

FIG. 5 is a chart illustrating the relationship between a distance Da and a gain deviation.

FIG. 6A is a diagram illustrating an example of a case 400 and a ground plate 420. FIG. 6B is a diagram for explaining the position of an antenna 410 in case 400.

FIG. 7 is a chart illustrating the relationship between a distance db and a gain deviation.

FIG. 8 is a diagram for explaining the position of an antenna 30.

FIG. 9 is a diagram for explaining the position of an antenna 31.

FIG. 10 is a diagram illustrating the horizontal directivity of antennas 30 and 31.

FIG. 11 is a perspective view of a vehicular antenna device 11.

FIG. 12 is a diagram for explaining the position of an antenna 34.

FIG. 13 is a diagram illustrating the horizontal directivity of antennas 31 and 34.

FIG. 14 is a diagram illustrating the horizontal directivity of an antenna 34 in vehicular antenna devices 11 and X.

FIG. 15 is a diagram illustrating the horizontal directivity of an antenna 31 in vehicular antenna devices 11 and X.

FIG. 16 is a perspective view of a vehicular antenna device 12.

FIG. 17 is a diagram for explaining the position of an antenna 37.

FIG. 18 is a perspective view of a vehicular antenna device 13.

FIG. 19 is a diagram for explaining the position of an antenna 512a.

FIG. 20 is a perspective view of a vehicular antenna device 14.

FIG. 21 is a diagram illustrating the horizontal directivity of an antenna 30.

FIGS. 22A and 22B are each a perspective view illustrating the periphery of a substrate 41 of a vehicular antenna device 10.

FIG. 23 is a plan view illustrating the periphery of the substrate 41 of the vehicular antenna device 10.

FIGS. 24A to 24I are each a diagram for explaining another example set of an antenna 31 and a case 22.

FIGS. 25A to 25C are each a diagram for explaining another example of an antenna 34.

FIGS. 26A and 26B are each a perspective view illustrating the periphery of a substrate 40 of the vehicular antenna device 11.

FIG. 27 is a plan view illustrating the periphery of the substrate 40 of the vehicular antenna device 11.

FIGS. 28A and 28B are each a perspective view of a vehicular antenna device 15.

FIG. 29 is an explanatory diagram of a separation distance Dgv between the antenna 31 and an antenna 32.

FIGS. 30A and 30B are each a graph illustrating an example of the maximum axial ratio at an elevation angle of 90° when the separation distance Dgv is changed.

FIGS. 31A and 31B are each a graph illustrating an example of the maximum axial ratio at an elevation angle of 10° when the separation distance Dgv is changed.

FIGS. 32A and 32B are perspective views of vehicular antenna devices 16 and 17, respectively.

FIGS. 33A and 33B are perspective views of vehicular antenna devices 18 and 19, respectively.

### DESCRIPTION OF EMBODIMENTS

At least the following matters will become apparent from the descriptions of the present specification and the accompanying drawings.

Preferred embodiments of the present disclosure will be described below with reference to the drawings. The same or equivalent constituent elements, members, and the like illustrated in the drawings are denoted by the same reference numerals, and overlapping explanations will be omitted as appropriate.

### EMBODIMENTS

### Overview of Vehicular Antenna Device 10 (First Embodiment)

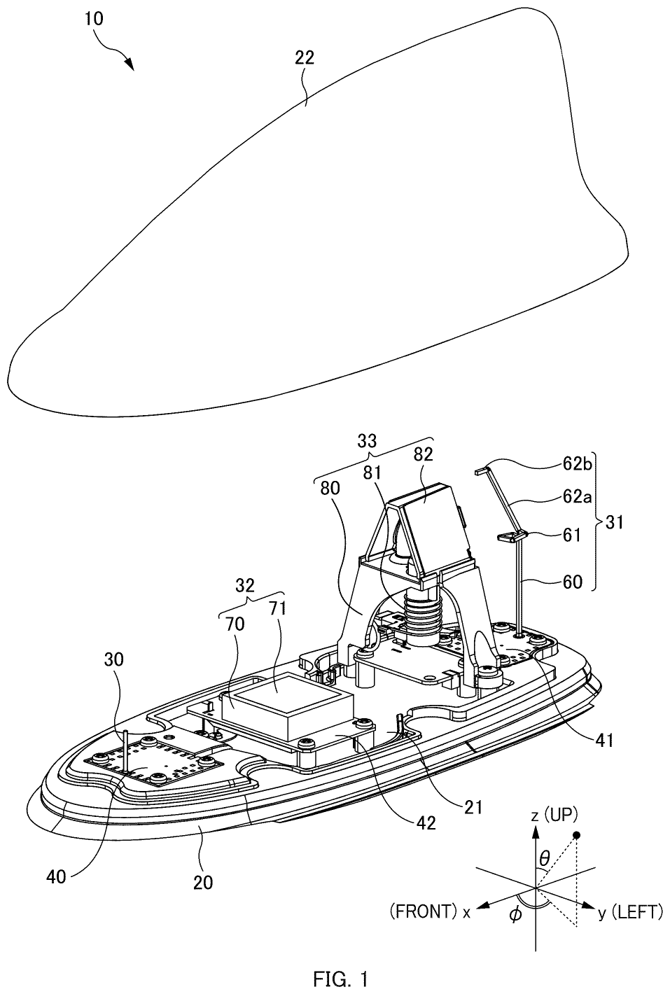

FIG. 1 is a diagram illustrating a configuration of the vehicular antenna device 10 according to a first embodiment of the present disclosure. FIG. 1 is a perspective view of the vehicular antenna device 10 with the case 22 removed in the zenith direction (upward direction). The vehicular antenna device 10 is a device to be mounted at the upper surface roof of a vehicle (not illustrated) and includes an antenna base 20, a case 22, antennas 30 to 33, and substrates 40 to 42.

In FIG. 1, the front-rear direction of the vehicle in which the vehicular antenna device 10 is mounted is defined as the x direction, the right-left direction perpendicular to the x direction as the y direction, and the vertical direction perpendicular to both the x direction and y direction as the z direction. Furthermore, the direction to the front side from the driver's seat of the vehicle is defined as the +x direction, the direction to the left side therefrom as the +y direction, and the zenith direction (upward direction) as the +z direction. Moreover, the +x direction (forward direction) is set as the azimuth angle φ=0°, the +y direction (left direction) as the azimuth angle φ=90°, and the +z direction as the zenith angle θ=0°. In the following description of an embodiment of the present disclosure, it is assumed that the front-rear, right-left, and up-down directions of the vehicular antenna device 10 are the same as the front-rear, right-left, and up-down directions of the vehicle.

The antenna base 20 is a plate-shaped member that serves as the bottom surface of the vehicular antenna device 10. The antenna base 20 includes, for example, a resin insulating base and a metal base 21, and the metal base 21 is mounted at the insulating base with a plurality of screws (not illustrated). The metal base 21 is a plate-shaped member that functions as a ground for the vehicular antenna device 10 with the vehicular antenna device 10 being attached to the roof (not illustrated) of the vehicle. It is assumed that although the antenna base 20 is configured such that the metal base 21 is directly mounted to the insulating base, the present disclosure is not limited to this. For example, the antenna base 20 may be configured only with a metal base or metal plate, or may be mounted with another member such as an insulating base or metal plate. The antenna base 20 may include an insulating base and a metal plate, or may include an insulating base, a metal base, and a metal plate. Alternatively, a configuration using a pad for waterproof surrounding a metal base may be used without using an insulating base.

The metal base 21 is formed as an integral metal base mounted with the substrates 40 to 42, as illustrated in FIG. 1. However, the metal base mounted with the substrates 40 to 42 may not be an integral metal base. For example, the substrates 40 to 42 may be mounted to respective separate metal bases, or the metal base mounted with the substrate 40 and substrate 42 and the metal base mounted with the substrate 41 may be separated. Also, at this event, the separate (divided) metal bases may be electrically connected with another metal base or another metal plate, and may further be held by a resin insulating base. Further, a metal plate may be used instead of a metal base, or a combination of a metal base and a metal plate may be used.

The case 22 is a member (so-called radome) that covers the antenna base 20 to form an accommodation space to accommodate the antennas 30 to 33 with the antenna base 20. The case 22 is made of synthetic resin having electromagnetic wave permeability (e.g., ABS resin), and has a shark fin shape whose height is low in the front and increases toward the rear.

Then, the case 22 is mounted to the antenna base 20 such that the opening on the lower side of the case 22 is closed by the antenna base 20. The outer dimensions of the case 23 of an embodiment of the present disclosure are, for example, such that the length in the front-rear direction is substantially 190 mm to 200 mm, the length in the up-down direction is substantially 60 mm to 65 mm, and the length in the right-left direction is substantially 70 mm to 75 mm. Moreover, a pad, which is an elastic member, may be provided between the antenna base 20 and the case 22.

### <<Overview of Antennas 30 and 31>>

Each of the antennas 30 and 31 is an antenna supporting radio waves in the V2X frequency band (vertically polarized waves that are linearly polarized waves). Specifically, the antennas 30 and 31 are used in the vehicular antenna device 10 to transmit V2X radio waves (e.g., in the 5.9 GHZ band) and to receive V2X radio waves using a spatial diversity system.

The antenna 30 is installed at the substrate 40 that is mounted to the front portion of the metal base 21. Although the details will be described later, the antenna 30 is mainly located in the front of the vehicular antenna device 10 and communicates with another V2X antenna (not illustrated).

Meanwhile, the antenna 31 is installed at the substrate 41 mounted to the rear portion of the metal base 21. The antenna 31 is mainly located in the rear of the vehicular antenna device 10 and communicates with another V2X antenna (not illustrated).

### <<Details of Antenna 30>>

The antenna 30 is a vertically polarized wave monopole antenna used for V2X communication. The antenna 30 is a rod-shaped metal member configured to operate as a grounded monopole antenna, and has a feeding point (not illustrated) provided at one end thereof on the substrate 40 side. Thus, the antenna 30 can exchange signals with a signal processing circuit (not illustrated) via the feeding point and the substrate 40.

The length from one end to the other end of the antenna 30 of an embodiment of the present disclosure is one-fourth of one wavelength of the V2X frequency band. It is assumed that one wavelength of the V2X frequency band is λ (substantially 50 mm), and accordingly the length of the antenna 30 is λ/4 (substantially 12.5 mm). Also, since the antenna 30 is mounted at the front surface of the substrate 40 so as to be substantially vertical thereto, the height of the antenna 30 from the front surface of the substrate 40 is λ/4 (substantially 12.5 mm) as well.

In an embodiment of the present disclosure, the length (physical length) and distance of the antenna may be described as a so-called electrical length, such as λ/4, using one wavelength λ of the V2X frequency band. At this event, the electrical length includes not only a single value, but also values that deviate by substantially a predetermined value (e.g., a value of 1/32 of λ). This is because the wavelength is not necessarily represented by a divisible integer, and the electrical length varies depending on various factors such as the material of the target object and the environment. Thus, in an embodiment of the present disclosure, for example, λ/4 means substantially λ/4. Hereinafter, for example, a predetermined electrical length (e.g., λ/4) may be given λ/4 or substantially λ/4. But even when it is simply given λ/4 without “substantially,” it is recognized as including substantially λ/4.

### <<Details of Antenna 31>>

The antenna 31 is a vertically polarized wave collinear antenna array used for V2X communication. The antenna 31 is a rod-shaped metal member mounted to the substrate 41 and includes a linear portion 60, an annular portion 61, a linear portion 62a, and a bent portion 62b.

The linear portion 60 has a length of λ/2, and a feeding point (not illustrated) is provided at one end on the substrate 41 side. The linear portion 62a is provided on the other end side of the linear portion 60, with the annular portion 61 interposed therebetween. In addition, the linear portion 62a extends from the annular portion 61 so that the antenna 31 does not come into contact with the case 22. Specifically, the linear portion 62a extends from the annular portion 61 so as to be inclined by a predetermined angle in the +x direction from the vertical direction.

In an embodiment of the present disclosure, the bent portion 62b is provided at the tip of the linear portion 62a so as to reliably prevent contact between the antenna 31 and the case 22. However, the linear portion 62a may extend in a vertical direction from the annular portion 61, and the provision of the bent portion 62b is not needed, if the height of the case 22 is high enough to prevent contact between the antenna 31 and the case 22, for example.

Here, the length of the tip from the end portion of the linear portion 62a on the annular portion 61 side to the bent portion 62b in an embodiment of the present disclosure is λ/2. Thus, in the antenna 31, the linear portion 60 having a length of λ/2, and the linear portion 62a having a length of λ/2 and bent portion 62b are provided on respective sides of the annular portion 61. Here, for example, if the phase of the vertically polarized wave in the linear portion 60 and the phase of the vertically polarized wave in the linear portion 62a and bent portion 62b are reversed, the gain of the antenna 31 decreases.

Thus, in an embodiment of the present disclosure, the annular portion 61, which is formed by winding in a spiral shape for one turn, is provided to adjust the phase of the vertically polarized wave in the linear portion 60 and the phase of the vertically polarized wave in the linear portion 62a and bent portion 62b, so that the gain in the desired frequency band at the antenna 31 increases. Accordingly, the antenna 31 with such a configuration can, for example, increase the gain of radio waves in the V2X frequency band.

It is assumed here that the antenna 30 is a rod-shaped monopole antenna and the antenna 31 is a collinear antenna array, but they are not limited to the above. Although details will be described later, the antennas 30 and 31 may be, for example, dipole antennas or patch antennas, as long as they are antennas (including grounded and non-grounded) supporting vertically polarized waves in the desired frequency band. Further, although the antennas 30 and 31 are V2X-compatible antennas, they may be of other communication standards (e.g., Wi-Fi (registered trademark) or Bluetooth (registered trademark)).

### <<Antenna 32>>

The antenna 32 is, for example, a patch antenna to receive radio waves in the 1.5 GHz band for the Global Navigation Satellite System (GNSS). The antenna 32 of an embodiment of the present disclosure is installed at the substrate 42 mounted to the metal base 21, and includes a dielectric member 70 and a radiation element 71.

The substrate 42 is provided, in the metal base 21, closer to the substrate 40 between the substrate 40 provided most forward and the substrate 41 provided most rearward. Thus, the antenna 32 is provided closer to the antenna 30 between the antenna 30 and antenna 31.

The dielectric member 70 is made of a dielectric material such as ceramic, and is a substantially square plate-shaped or box-shaped member in a plan view of the x-y plane viewed from the +z direction. In the back surface of the dielectric member 70, a conductor functioning as a ground conductor film (or ground conductor plate) is formed. Then, the back surface of the dielectric member 70 is mounted to the substrate 42 using, for example, an adhesive (not illustrated).

In the front surface of the dielectric member 70, a substantially square conductive radiation element 71 having equal vertical and horizontal lengths is formed. Here, the “substantially square” also includes a shape in which at least one or more of the corners thereof are cut off obliquely with respect to the sides thereof, and a shape in which any of the sides is provided with a cutout (recessed portion) or protrusion (protruding portion). The shape of the dielectric member 70 is not limited to a substantially square shape, and may be a quadrilateral shape such as a substantially rectangular shape, or a shape such as a substantially circular shape or a substantially elliptical shape.

Moreover, the radiation element 71 is provided with two feeding points (not illustrated). In addition, although not illustrated here for convenience, two feed lines are respectively connected to the two feeding points through two through-holes (not illustrated) that penetrate the substrate 42 and the dielectric member 70. By distributing power with a phase difference to these feed lines, they operate as circularly polarized antennas. Although it is assumed that the antenna 32 is a GNSS antenna, it may also be an antenna to receive radio waves of other standards, such as Satellite Digital Audio Radio Service (SDARS).

### <<Antenna 33>>

The antenna 33 is an antenna to receive radio waves in the DAB (Digital Audio Broadcast) waveband, for example. Specifically, the antenna 33 receives, for example, radio waves in Band-III (174 MHZ to 240 MHZ). The antenna 33 includes a holder 80, a helical element (hereinafter simply referred to as “coil”) 81 and a capacitively loaded element 82. In an embodiment of the present disclosure, the antenna 33 receives radio waves in Band-III (174 MHz to 240 MHZ), but the band may be, for example, another band of the DAB (Digital Audio Broadcast) waveband, such as L-Band (1452 MHz to 1492 MHZ).

The holder 80 is a resin member to hold the coil 81 and the capacitively loaded element 82 and is mounted to the metal base 21. The coil 81 is mounted to the cylindrical portion of the holder 80. In addition, the coil 81 has one end configured to be electrically connected to a circuit board (not illustrated) provided at the metal base 21, and the coil 81 has the other end configured to be electrically connected to the capacitively loaded element 82.

The capacitively loaded element 82 is an element configured to resonate in the desired frequency band with the coil 81, and is a metal body having two quadrilateral bodies respectively attached, at the lower parts thereof, to the left and right sides of the upper part of the holder 80. In FIG. 1, for convenience, only the metal body on the right side of the upper part of holder 80 is illustrated, but there is also a metal body as with the metal body on the right side attached to the left side of holder 80. Furthermore, the capacitively loaded element 82 includes a lower metal body (not illustrated) connecting the left and right metal bodies.

Here, the “metal body” refers to an object formed by processing a metal member, including, for example, a three-dimensional metal member other than non-plate-shaped member, in addition to a plate-shaped metal member such as a metal plate. For example, the right-side metal body and the left-side metal body may be connected at the apex portion, or integrally formed, and may have three-dimensional shapes such as an inverted V-shape, inverted U-shape, mountain-like shape, or a shape obtained by excluding the bottom edge of a trapezoid, when viewed from the front or rear.

In an embodiment of the present disclosure, the holder 80 is installed such that the distance between the rear end portion of the capacitively loaded element 82 and the tip of the bent portion 62b in the antenna 31 is, for example, shorter than the one wavelength λ of the V2X frequency band. Also, in an embodiment of the present disclosure, the length of the side in the rear of the capacitively loaded element 82 is, for example, λ/2, but it may be designed slightly longer than λ/2. In such a case, the capacitively loaded element 82 will operate as a reflector for the antenna 31, which enables the improvement of the gain of the antenna 31.

As such, in an embodiment of the present disclosure, since the antenna 33 is used as a reflector, the antenna 33 is provided closer to the antenna 31 between the antenna 30 and antenna 31.

### <<Relationship Between V2X Antenna and Case 22>>

In the vehicular antenna device 10, the V2X antennas 30 and 31, the GNSS antenna 32, and the DAB antenna 33 as described above are provided. Among these antennas, the V2X antennas 30 and 31 have the highest operating frequency band of 5 GHz band and a shortest wavelength λ of substantially 50 mm. Thus, the case 22 may affect the directivity of the antennas 30 and 31.

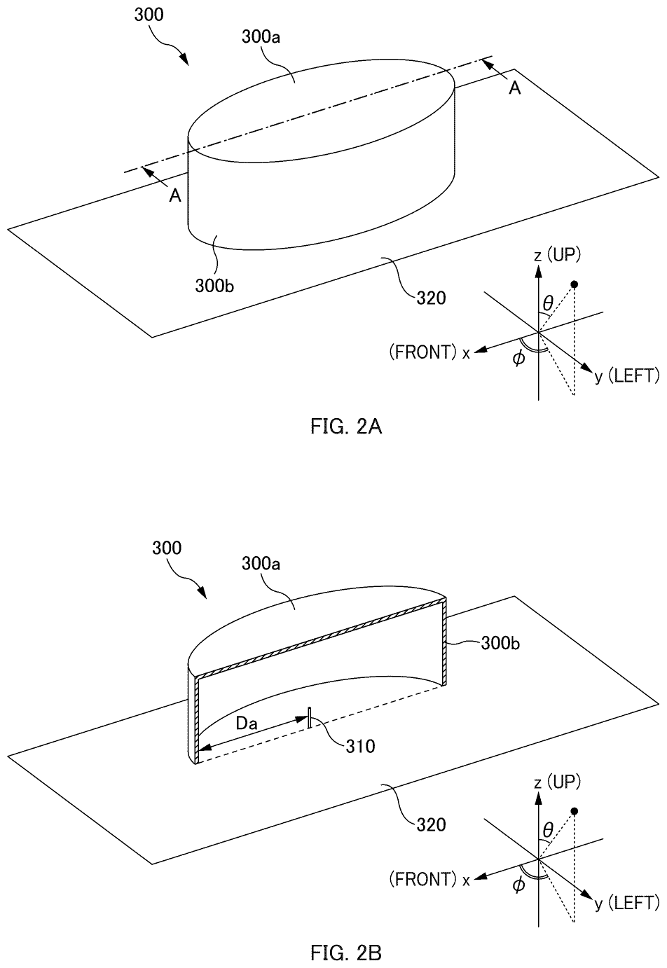

Accordingly, here, a model simulating the vehicular antenna device 10 is used to verify the influence of the case on the directivity of the antenna. First, referring to the model of FIG. 2, the relationship between the position of the antenna of the vehicular antenna device and the case is verified.

### <<Regarding Case 300 and Antenna 310>>

FIG. 2A is a diagram illustrating an example of a case 300 and a ground plate 320. FIG. 2B is a diagram for explaining the position of an antenna 310. FIG. 2B is a cross sectional view of the case 300 taken along line A-A of FIG. 2A such that the antenna 310 inside the case 300 can be seen. Further, in FIG. 2B, the longitudinal axis (the axis on the major diameter) passing through the geometric center of the elliptical bottom surface of the case 300 is depicted by a dotted line.

The case 300 includes an elliptical top surface 300a when viewed in a plan view of the x-y plane from the +z direction, and a cylindrical member 300b extending, in the −z direction (downward direction), from the outer periphery of the top surface 300a. In addition, in an embodiment of the present disclosure, the cylindrical member 300b is formed such that when the case 300 is installed at the ground plate 320 placed on the x-y plane, the ground plate 320 and the top surface 300a are parallel, and the angle formed by the ground plate 320 and the cylindrical member 300b is 90°. The major diameter of the top surface 300a is 220 mm, and the minor diameter is 110 mm. Additionally, the height of the cylindrical member 300b (the distance from the ground plate 320 to the top surface 300a) is 55 mm.

The antenna 310 is a monopole antenna capable of supporting vertically polarized waves in the V2X frequency band. Since the antenna 310 is grounded to the ground plate 320, the length of the antenna 310 is λ/4 (substantially 12.5 mm). In addition, in an embodiment of the present disclosure, the distance from the inside of the cylindrical member 300b on the +x-side to the antenna 310, along the longitudinal axis (axis on the major diameter), as depicted by the dotted line in FIG. 2B, passing through the center (geometric center) of the top surface 300a, is referred to as distance Da.

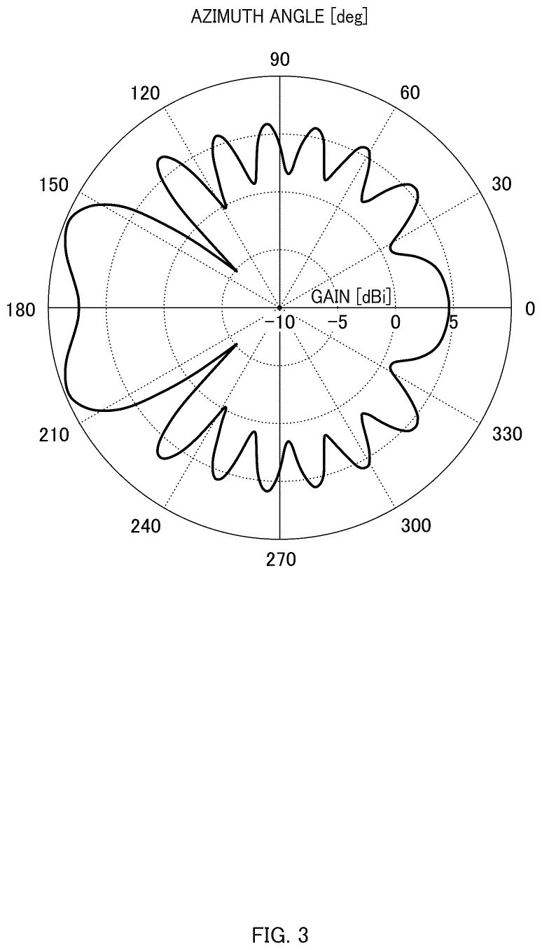

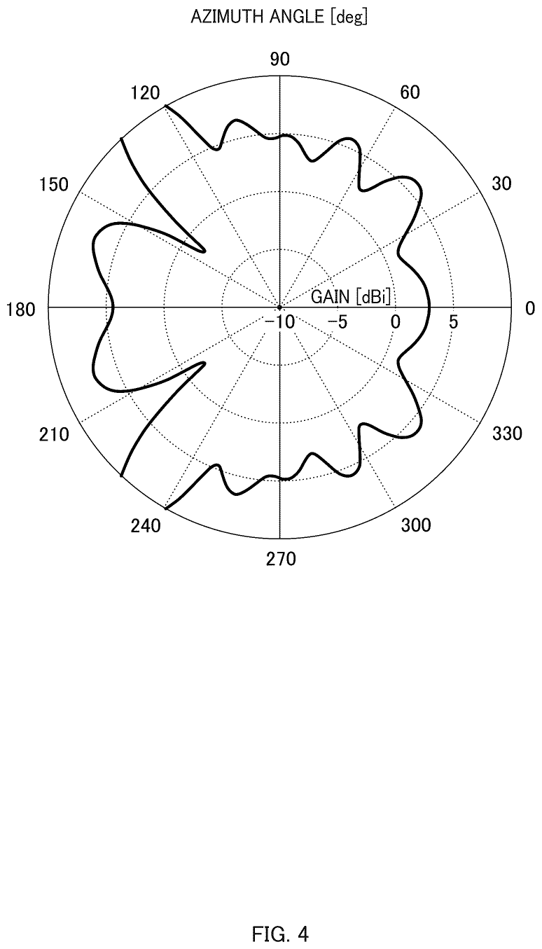

FIG. 3 is a diagram illustrating the horizontal directivity of the antenna 310 at a distance Da=20 mm, and FIG. 4 is a diagram illustrating the horizontal directivity of the antenna 310 at a distance Da=50 mm. Specifically, FIGS. 3 and 4 are calculation results illustrating how the gain (dBi) in the horizontal plane of vertical variation of the antenna 310 varies in all directions. In an embodiment of the present disclosure, an azimuth angle of 0° corresponds to the +x direction (forward direction), and an azimuth angle of 90° corresponds to the +y direction (left direction).

As is apparent from comparison between FIGS. 3 and 4, as the distance Da increases, the gain at the azimuth angle of 0° decreases, and the gain of the antenna 310 greatly increases near the azimuth angles of 1200 and 240°, for example. Accordingly, the longer the distance Da, the more the directivity of the antenna 310 in the forward direction tends to deteriorate, which will be described later in detail.

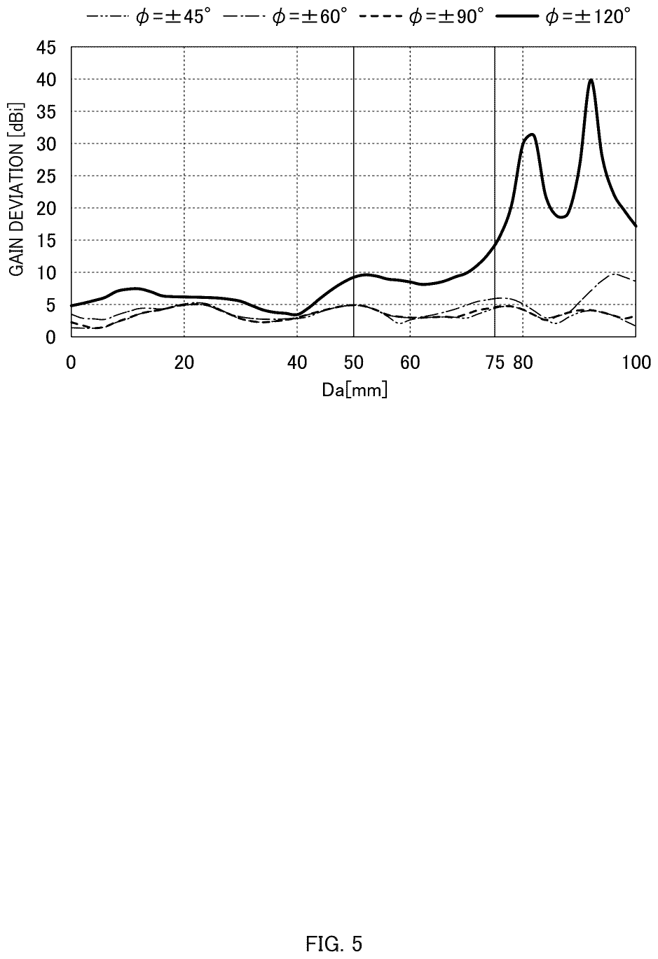

FIG. 5 is a chart illustrating the relationship between gain deviation and distance Da in the range of φ=±45° to 120°. Here, the range of ±φ (hereinafter referred to as “range of predetermined angles”) is based on an azimuth angle of 0°, and includes the range up to φ° counterclockwise (+ direction) and the range up to φ° clockwise (− direction). Thus, for example, the range of φ=±120° includes the range from azimuth angle of 0° to 120° (i.e., azimuth angle 120°) and the range from azimuth angle 0° to 120° in the clockwise (− direction) (i.e., azimuth angle 240°). Furthermore, the “gain deviation” refers to the difference between the maximum gain and the minimum gain within the range of predetermined angles.

As illustrated in FIG. 5, even when the distance Da is long, the gain deviations at φ=±45°, ±60°, and ±90° are generally within the range of 5 dBi, although there are some exceptions. Meanwhile, the gain deviation at φ=±120° indicated by the solid line in FIG. 5 increases to substantially 10 dBi near the distance Da of 50 mm, and then decreases. Thereafter, the gain deviation gradually increases from the vicinity of the distance Da of 75 mm, and reaches substantially 31 dBi at the distance Da of 82 mm. Moreover, when the distance Da exceeds 82 mm, it fluctuates greatly within a range of substantially 20 dBi to 40 dBi.

Here, as described above, in the vehicular antenna device 10, the antennas 30 and 31 receive vertically polarized waves by a so-called diversity system. In such a case, even the front antenna 30 preferably has good directivity within a certain angular range with the front as the center (e.g., φ=±120° with reference to 0°). Similarly, even the rear antenna 31 preferably has good directivity within a certain angular range with the rear as the center (e.g., φ=±1200 with reference to 180°). Thus, both the antennas 30 and 31 preferably have a small gain deviation in a wide angular range (e.g., the range of φ=±120°).

Accordingly, when installing the antenna 310 within the case 300, it is preferable to set the distance Da to be equal to or less than the distance (75 mm) at which the gain deviation at φ=±120° starts to significantly increase toward 30 dBi, as illustrated in FIG. 5. Furthermore, in order to further decrease the gain deviation at φ=±120°, it is more preferable to set the distance Da to be equal to or less than the distance (50 mm) at which the gain deviation peaks at substantially 10 dBi. The preferable distance of 75 mm for reducing gain deviation corresponds to three-halves of one wavelength λ of the V2X frequency band ((3×λ)/2), and 50 mm corresponds to one wavelength λ.

### <<Regarding Case 400 and Antenna 410>>

The shape of the end portion on the +x-side of the case 300 illustrated in FIGS. 2A and 2B is similar to the shape on the rear side (−x-side) of the shark-fin-type case 22 of FIG. 1, for example. Thus, next, a case having a shape on the front side (+x-side) similar to that of the shark-fin-type case 22 is used, to carry out the same verification as in FIG. 2.

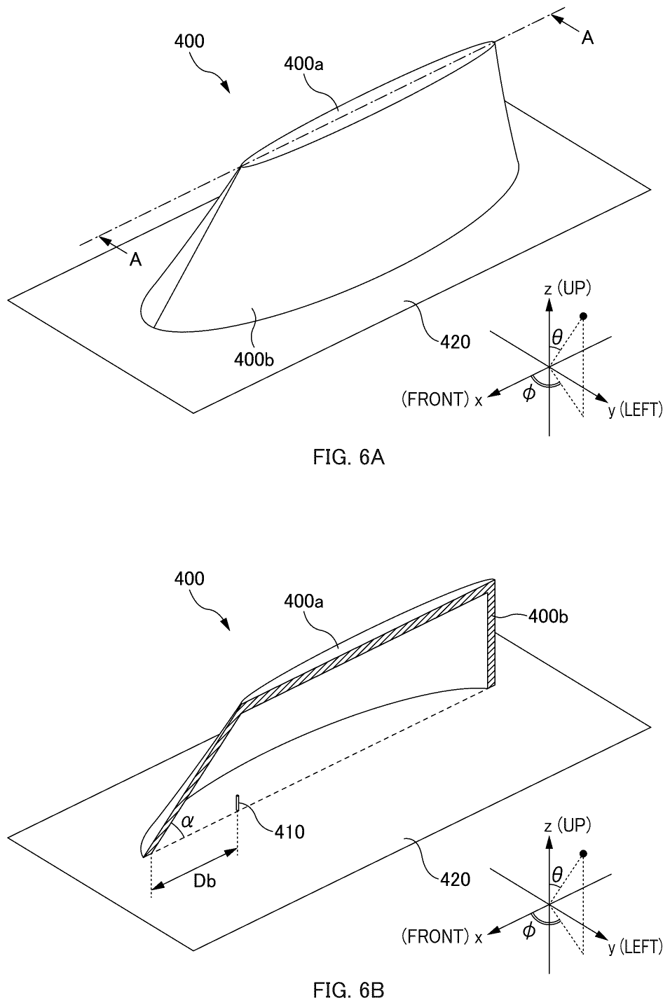

FIG. 6A is a diagram illustrating an example of a case 400 and a ground plate 420. FIG. 6B is a diagram for explaining the position of an antenna 410. FIG. 6B is a cross sectional view of the case 400 taken along line A-A of FIG. 6A such that the antenna 410 inside the case 400 can be seen. Further, in FIG. 6B, the longitudinal axis (the axis on the major diameter) passing through the geometric center of the elliptical bottom surface of the case 400 is depicted by a dotted line.

The case 400 includes an elliptical top surface 400a when viewed in a plan view of the x-y plane from the +z direction, and a cylindrical member 400b extending, in the −z direction (downward direction), from the outer periphery of the top surface 400a. In addition, in an embodiment of the present disclosure, the cylindrical member 400b is formed such that when the case 400 is installed at a ground plate 420 placed on the x-y plane, the height of the accommodation space in the front portion of the case 400 gradually increases, and the ground plate 420 and the top surface 400a are parallel.

Specifically, the cylindrical member 400b is formed such that the angle formed between a straight line from the foremost portion (the portion in the most +x direction) of the case 400 on the ground plate 420 to the top surface 400a and the ground plate 420 is angle α (e.g., 40°). Furthermore, the cylindrical member 400b is formed such that the angle formed between a straight line from the rearmost portion (the portion in the most −x direction) of the case 400 on the ground plate 420 to the top surface 400a and the ground plate 420 is 90°.

In the case 400 as such, the top surface 400a has a major diameter of 161 mm and a minor diameter of 20 mm. Further, the height of the cylindrical member 400b (the distance from the ground plate 420 to the top surface 400a) is 55 mm. Further, the major diameter and minor diameter of the elliptical bottom surface of the case 400 are 220 mm and 45 mm, respectively.

The antenna 410 is a monopole antenna capable of supporting vertically polarized waves in the V2X frequency band, similar to the antenna 310 illustrated in FIG. 2. Thus, detailed description is omitted here. In addition, here, the distance from the inner tip portion of the cylindrical member 400b on the +x-side to the antenna 410 in the longitudinal axis passing through the geometric center of the elliptical bottom surface of the case 400 is referred to as a distance Db.

The height of the case 400 gradually increases from the tip portion toward the rear until it reaches a predetermined height (55 mm), but the antenna 410 cannot be installed on the front portion of the case 400 where the height of the case 400 is lower than the height of the antenna 410. As described above, in an embodiment of the present disclosure, the length of the antenna 410 is λ/4 (substantially 12.5 mm), and the angle α is 40°. Thus, within the case 400, the antenna 410 needs to be arranged at least the distance Db of substantially 14 mm or more apart therefrom. In the case 400, the distance Db=14 mm is a distance at which the antenna 410 can be arranged in contact with the case 400. In the following, in an embodiment of the present disclosure, the position at distance Db=14 mm is referred to as the “reference position.”

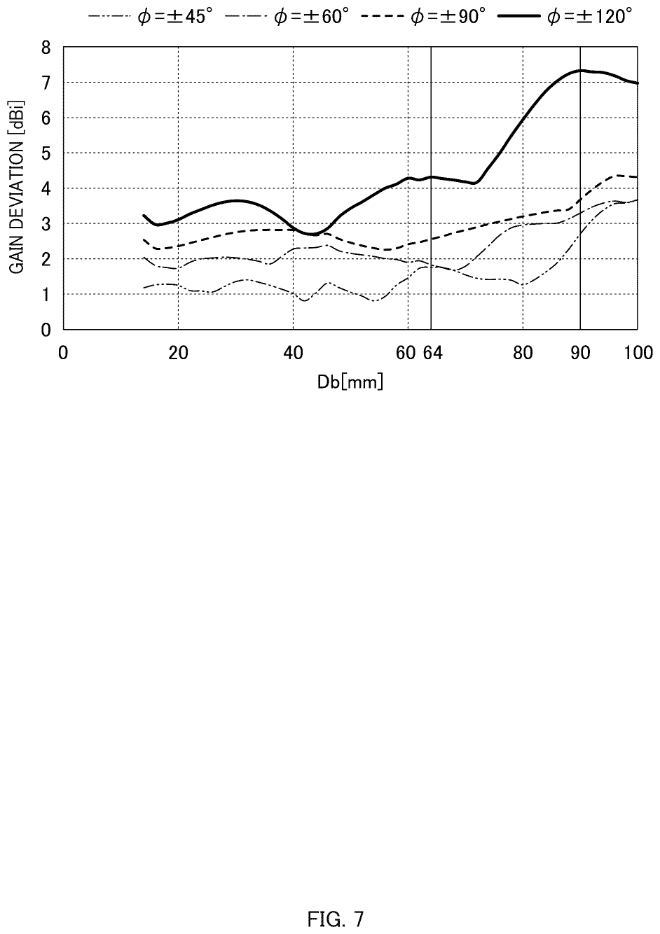

FIG. 7 is a chart illustrating the relationship between distance Db and gain deviation. In any case of φ=±45°, ±60°, ±90°, and ±120°, the smaller the distance Db, the smaller the gain deviation tends to be, and in particular, when the distance Db is 80 mm or greater, the gain deviation tends to gradually increase. However, as described above, it is preferable for the antenna 410 to have good directivity in a wide angular range (e.g., φ=±120°).

The gain deviation when (=±1200 indicated by the solid line in FIG. 7 increases as the distance Db increases from 14 mm (reference position), and then decreases to substantially 2.7 dBi in the vicinity of 44 mm (reference position+30 mm). Further, the gain deviation when (=±1200 gradually increases from the vicinity of 44 mm (reference position+30 mm) of the distance Db, and reaches a peak value (4.3 dBi) in the vicinity of 64 mm (reference position+50 mm).

Thereafter, as the distance Db increases, the gain deviation when (=±1200 decreases once, then increases again, and reaches a peak value (7.3 dBi) again in the vicinity of 90 mm (reference position+76 mm). Moreover, when the distance Db becomes longer than 90 mm (reference position+76 mm), the gain deviations when (=±45°, ±60°, and ±90° gradually increase as well.

Accordingly, in order to suppress increase in the gain deviation while the antenna 410 is arranged inside the case 400, it is preferable to set the distance Db to 90 mm (reference position+76 mm) or less. In addition, in practice, if the distance Db is set to 64 mm (reference position+50 mm) or less, it becomes possible to suppress the gain deviation in the range of φ=±450 to ±1200 to a predetermined value (substantially 4 dBi) or less, which is more preferable.

### <<Regarding Desired Position of Antenna>>

Setting the distance Db to 90 mm or less, or 64 mm or less, is equivalent to setting the distance to 76 mm or less, or 50 mm or less, from the reference position, at which the antenna contacts the case. These distances are substantially the same as the preferred distances (75 mm or 50 mm) with respect to the distance Da in the case of FIG. 2. Accordingly, in either case of FIG. 2 or 6, when a V2X antenna is arranged inside the case, the directivity can be improved by providing the contact portion of the antenna with the case at a distance of substantially 75 mm (three-halves of one wavelength: (3×λ)/2) or less, or more preferably, substantially 50 mm (one wavelength: λ) or less, from the position at which the antenna contacts the case.

In the following, in an embodiment of the present disclosure, it is assumed that a portion of the antenna to be in contact with the case is placed at a “desired position,” which is a position separated by a distance of, for example, equal to or less than three-halves of the V2X wavelength (3λ/2) in the horizontal direction. Furthermore, although the details will be described later, the “portion of the antenna to be in contact with the case” refers to the portion that would virtually come into contact with the case when the antenna is moved in the horizontal direction from its actual installation position.

### <<Installation Position of Antenna 30>>

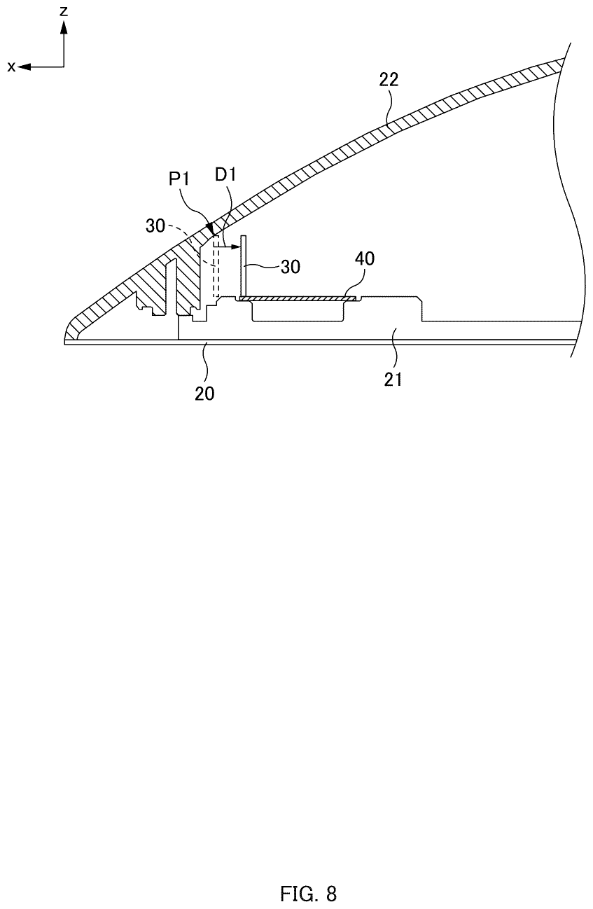

FIG. 8 is a diagram for explaining the position of the front antenna 30 in the vehicular antenna device 10. For ease of understanding, FIG. 8 is a cross sectional view of the case 22 taken along a line along the x-axis direction passing through the center point of the case 22 in the right-left direction.

In an embodiment of the present disclosure, the position of the antenna 30 is determined such that a portion of the antenna 30 is at the desired position described above. Specifically, in an embodiment of the present disclosure, the antenna 30 (tip portion P1) is provided at a position separated rearward by a distance D1 from the position at which the tip portion P1 of the antenna 30 contacts the case 22. Here, the distance D1 is a distance (e.g., 5 mm) shorter than substantially 75 mm, which is three-halves of the V2X wavelength (3λ/2). Ideally, the antenna 30 should be placed close to the case 22, but if it is brought into contact therewith, a load is applied to the antenna 30 due to the vibration of the vehicle, and thus it is separated slightly therefrom. In FIG. 8, the state in which the tip portion P1 of the antenna 30 is in contact with the case 22 is indicated by a dotted line for convenience, but this is a virtual state.

### <<Installation Position of Antenna 31>>

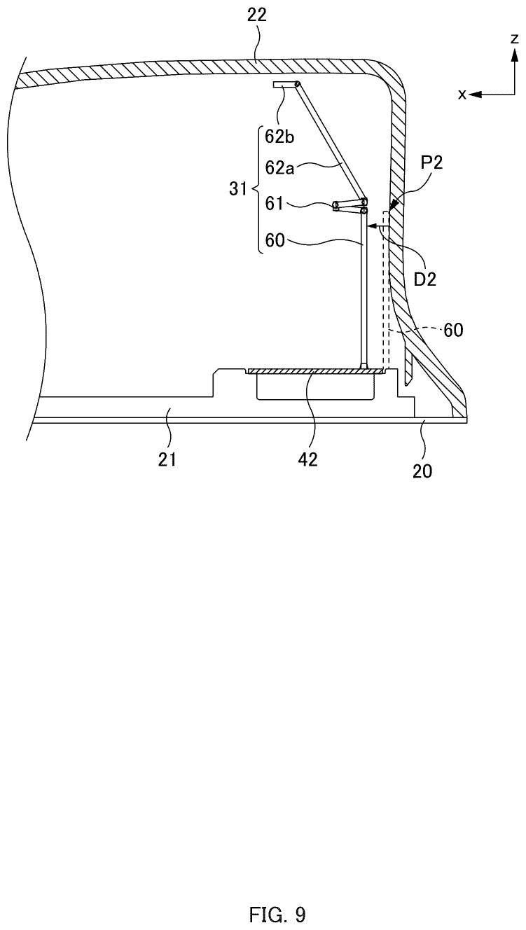

FIG. 9 is a diagram for explaining the position of the rear antenna 31 in the vehicular antenna device 10. FIG. 9 is also a cross sectional view of the case 22 in the same manner as in FIG. 8.

In an embodiment of the present disclosure, the position of the antenna 31 is determined such that a portion of the antenna 31 is at the desired position described above. Specifically, in an embodiment of the present disclosure, for example, the antenna 31 (end portion P2) is provided at a position separated forward by a distance D2 from the position at which the end portion P2 of the linear portion 60 on the annular portion 61 side in the antenna 31 contacts the case 22. Here, the distance D2 is a distance (e.g., 5 mm) shorter than substantially 75 mm, which is three-halves of the V2X wavelength (3λ/2). Ideally, the antenna 31 should be placed close to the case 22, but if brought into contact therewith, a load is applied to the antenna 31 due to the vibration of the vehicle, and thus it is separated slightly therefrom. In FIG. 9, the dotted line indicates a virtual state in which the end portion P2 of the linear portion 60 is in contact with the case 22.

### <<Horizontal Directivity of Antennas 30 and 31>>

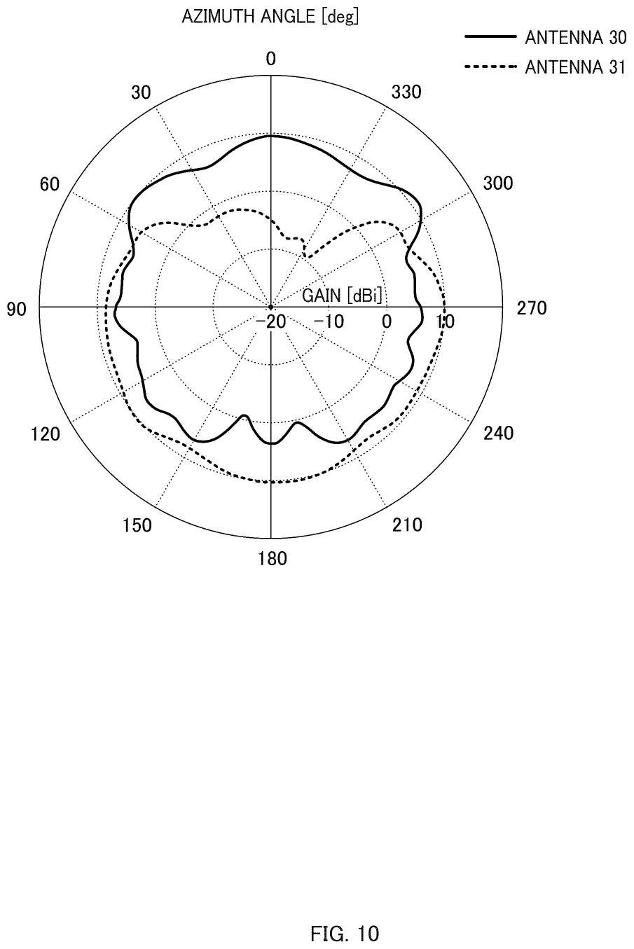

FIG. 10 is a diagram illustrating the horizontal directivity of the antennas 30 and 31 installed in the vehicular antenna device 10. In FIG. 10, the solid line indicates the directivity of the antenna 30 and the dotted line indicates the directivity of the antenna 31. Further, as described above, an azimuth angle of 0° corresponds to the +x direction (forward direction), and an azimuth angle of 90° corresponds to the +y direction (left direction).

FIG. 10 provides simulation results illustrating the horizontal directivity of the antennas 30 and 31 when an infinite ground plate is used. As illustrated in FIG. 10, in an embodiment of the present disclosure, although there are some exceptions, the vehicular antenna device 10 can achieve a gain that is slightly smaller than 10 dBi with respect to vertically polarized waves in the V2X frequency band in the front, rear, right, and left directions on the infinite ground plate. As such, when the antennas 30 and 31 are used, good directivity can be obtained in the horizontal plane.

Here, the vehicular antenna device 10 illustrated in FIG. 1 is a so-called composite antenna device, and includes the GNSS antenna 32 and the DAB antenna 33 in addition to the V2X antennas 30 and 31. In such a composite antenna device, individual antennas needs to be arranged so that unnecessary electrical interference does not occur among the antennas.

In an embodiment of the present disclosure, as illustrated in FIG. 8, the antenna 30 is arranged at a position close to the front portion of the case 22 (e.g., the distance D1=5 mm). Further, as illustrated in FIG. 9, the antenna 31 is arranged at a position close to the rear portion of the case 22 (e.g., the distance D2=5 mm). Thus, in the vehicular antenna device 10, it is possible to have a long distance between the front antenna 30 and the rear antenna 31.

Accordingly, in an embodiment of the present disclosure, the GNSS antenna 32 and the DAB antenna 33 can be arranged in the long interval between the antenna 30 and antenna 31.

Further, in an embodiment of the present disclosure, the antennas 30 and 31 carry out at least one of receiving or transmitting signals in the same frequency band. Moreover, antennas (here, antennas 32 and 33) of frequency bands lower than the frequency bands supported by the antennas 30 and 31 are arranged between the antenna 30 and antenna 31. Antennas supporting higher frequency bands are more likely to be affected by the case 22, and in contrast, antennas supporting lower frequency bands are less likely to be affected by the case 22. Thus, in an embodiment of the present disclosure, the antennas 30 and 31 are arranged on the outer side of the vehicular antenna device 10, and the antennas 32 and 33 are arranged on the inner side of the vehicular antenna device 10. By arranging the antennas as such, it is possible to improve the performance of each antenna.

Furthermore, the height of the antenna 30 is lower than the height of the antenna 31. Accordingly, in the vehicular antenna device 10, by setting the antenna system of the antennas 30 and 31 according to the front and rear positions at which the antennas are to be arranged, and to the space inside the case 22, it is possible to reduce the size of the vehicular antenna device 10 while securing the directivity and gain of the antennas 30 and 31.

In an embodiment of the present disclosure, the antennas 30 and 31, which support the same frequency band, have different antenna systems. However, the antennas 30 and 31 are not limited to the case of different antenna systems, and may be of the same antenna system depending on design requirements. As such, when the vehicular antenna device 10 has a plurality of antennas arranged therein, they may be a combination of antennas of the same antenna system, or may be antennas of antenna systems that are all different.

Further, the antennas 30 and 31 are arranged substantially in the center of the vehicular antenna device 10 in the width direction (Y direction). Thus, the directivity of the antennas 30 and 31 can be symmetrical with respect to the X-axis, which facilitates adjustment and control so as to provide directivity in the front-rear direction (X direction).

In an embodiment of the present disclosure, the antenna 32 is arranged such that the height of the top surface is lower than the top end of the antenna 30. In this case, the electrical properties of the antenna 30 are improved. The antenna 32 may be arranged so that the height of the top surface is higher than the top end of the antenna 30. In this case, the electrical properties of the antenna 32 are improved. That is, in an embodiment of the present disclosure, the height of the antennas arranged in the vehicular antenna device 10 can be selected depending on the application of design. This makes it possible to ensure the characteristics of the antennas arranged in the vehicular antenna device 10 without impairing the design of the vehicular antenna device 10, and achieve miniaturization as well.

Further, in an embodiment of the present disclosure, the antennas 30, 31, and 32 are installed at different substrates, respectively. However, at least two or more of the antennas 30, 31, and 32 may be installed at the same substrate. This makes it possible to improve ease of assembly of the antenna.

### <<Correspondence Relationship>>

In the vehicular antenna device 10 of FIG. 1, the antenna 30 corresponds to a “first antenna” and the antenna 31 corresponds to a “second antenna.” Further, for example, the antenna 32 corresponds to a “third antenna.”

Further, for example, the tip portion P1 of the antenna 30 corresponds to “at least a portion of the first antenna,” and the distance D1 corresponds to a “predetermined distance.” Further, the +x direction corresponds to a “first direction,” and the −x direction corresponds to a “second direction opposite to the first direction.”

In addition, for example, the end portion P2 of the linear portion 60 of the antenna 31 corresponds to “at least a portion of the second antenna,” and the distance D2 corresponds to a “predetermined distance.”

In addition, for example, the position separated by the distance D1 (i.e., the position of the tip portion P1 of the installed antenna 30) from the position at which the tip portion P1 of the antenna 30 contacts the case 22 corresponds to a “first position.” Similarly, the position separated by the distance D2 (i.e., the position of the end portion P2 of the installed antenna 31) from the position at which the end portion P2 of the antenna 31 contacts the case 22 corresponds to a “second position.”

### Vehicular Antenna Device 11 (Second Embodiment)

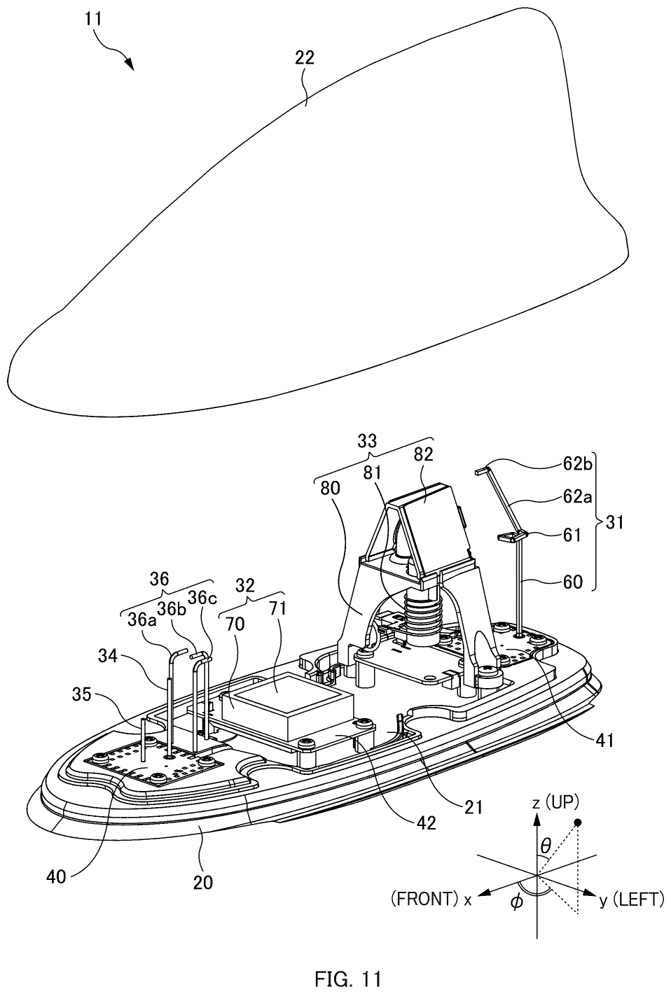

FIG. 11 is a diagram for explaining the configuration of the vehicular antenna device 11 of a second embodiment. FIG. 11 depicts a state in which the case 22 is removed in the zenith direction (upward direction). The vehicular antenna device 11 includes an antenna 34 and parasitic elements 35 and 36a to 36c, instead of the antenna 30 of the vehicular antenna device 10 of FIG. 1. Thus, the antenna 34 and the parasitic elements 35 and 36a to 36c will be described here. The three parasitic elements 36a to 36c may be hereinafter collectively referred to as a parasitic element 36.

The antenna 34 is a vertically polarized wave monopole antenna used for V2X communication, similarly to the antenna 30. The antenna 34 is a rod-shaped metal member configured to operate as a grounded monopole antenna, and has a feeding point (not illustrated) provided at one end thereof on the substrate 40 side. Thus, the antenna 30 can exchange signals with a signal processing circuit (not illustrated) via the feeding point and the substrate 40.

The length from one end to the other end of the antenna 34 of an embodiment of the present disclosure is a half of one wavelength of the V2X frequency band. Accordingly, the length of the antenna 34 is λ/2 (substantially 25 mm). Further, since the antenna 34 is mounted at the front surface of the substrate 40 so as to be substantially vertical thereto, the height of the antenna 34 from the front surface of the substrate 40 is also λ/2 (substantially 25 mm).

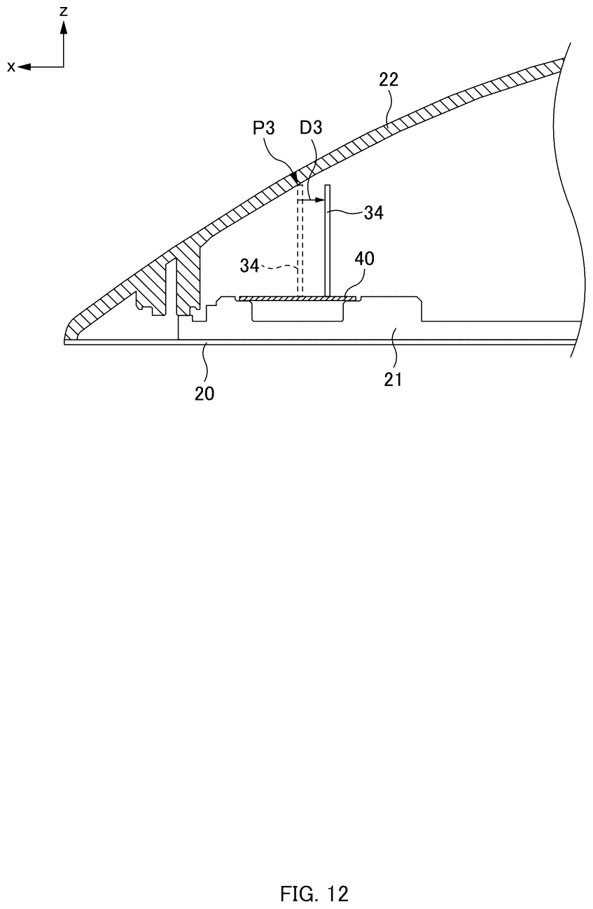

In addition, in an embodiment of the present disclosure, the position of the antenna 34 is determined such that a portion of the antenna 34 is at the desired position described above. Specifically, as illustrated in FIG. 12, the antenna 34 (tip portion P3) is provided at a position separated rearward by a distance D3 from the position at which the tip portion P3 of the antenna 34 contacts the case 22. Here, the distance D3 is a distance (e.g., 5 mm) shorter than substantially 75 mm, which is three-halves of the V2X wavelength (3λ/2). With the antenna 34 being installed at such a position, it is possible to improve the directivity of the antenna 34 while suppressing the influence of the case 22.

The parasitic elements 35 and 36 are elements to improve directivity while increasing the gain in front (+x direction) of the antenna 34. Specifically, the parasitic element 35 is a rod-shaped metal body that functions as a so-called director with respect to the antenna 34 and is installed on the front side relative to the antenna 34. Further, the parasitic element 35 is installed at the substrate 40 in a non-grounded state. The length of the parasitic element 35 is equal to or less than the length of the antenna 34 (λ/2).

Each of the parasitic elements 36a to 36c is a rod-shaped metal body that functions as a so-called reflector with respect to the antenna 34 and is installed on the rear side relative to the antenna 34. Thus, the parasitic elements 36a to 36c are provided between the antenna 30 and the antenna 32. In addition, the parasitic elements 36a to 36c are installed at the metal base 21 in a non-grounded state. Further, the length of each of the parasitic elements 36a to 36c is equal to or longer than the length of the antenna 34 (substantially λ/2).

The tip of each of the parasitic elements 36a to 36c in an embodiment of the present disclosure is bent, to thereby prevent the parasitic elements 36a to 36c from contacting the case 22. Accordingly, for example, when the accommodation space of the case 22 is sufficiently high, the parasitic elements 36a to 36c may be linear members.

Additionally, an aspect in which the parasitic elements 36a to 36c are bent may be different from that illustrated in FIG. 11. In the parasitic elements 36a to 36c illustrated in FIG. 11, the tips of the parasitic elements 36a and 36c are bent in the −x direction (rearward direction), and the tip of the parasitic element 36b is bent in the +x direction (forward direction). In other words, in the vehicular antenna device 11 illustrated in FIG. 11, the parasitic elements 36 that are bent in different directions coexist. However, for example, all of the parasitic elements 36a to 36c may be bent in the same direction.

In addition, in the vehicular antenna device 11 illustrated in FIG. 11, each of the parasitic elements 36a to 36c is bent at one position of the tip portion (upper portion). However, for example, each of the parasitic elements 36a to 36c may be bent at a lower portion, or may be bent at a plurality of positions. Furthermore, the angle at which each of the parasitic elements 36a to 36c is bent may not be 90° as illustrated in FIG. 11, but may be an angle at which the tips thereof are away from the case 22, for example. This can further prevent the parasitic elements 36a to 36c from coming into contact with the case 22, and further miniaturize the vehicular antenna device 11.

Additionally, in an embodiment of the present disclosure, it is preferable that the parasitic elements 35 and 36 are installed within a range of a virtual circle having a radius of λ/2 (hereinafter referred to as the “circle C”) with the position at which the antenna 34 is installed as the center thereof, so as to improve the forward gain of the antenna 34. Specifically, it is preferable that the parasitic element 35 is installed within the range of the half of the circle C on the +x side, and the parasitic element 36 is installed within the range of the half of the circle C on the −x side. With the parasitic elements 35 and 36 being installed in such ranges, it is possible to improve the horizontal directivity of the antenna 30.

Although both the parasitic elements 35 and 36 are provided in the vehicular antenna device 11, only one of them may be provided. Further, although three parasitic elements 36 operating as reflectors are provided, at least one parasitic element 36 may be provided.

Further, when the parasitic element 35 is grounded, the length of the parasitic element 35 is λ/4 or less, and when the parasitic element 36 is grounded, the length of the parasitic element 36 is λ/4 or more. In other words, in an embodiment of the present disclosure, the length of each of the parasitic elements 35 and 36 only has to be set such that they can appropriately operate as a director and a reflector with respect to the antenna 34.

### <<Horizontal Directivity of Antennas 31 and 34>>

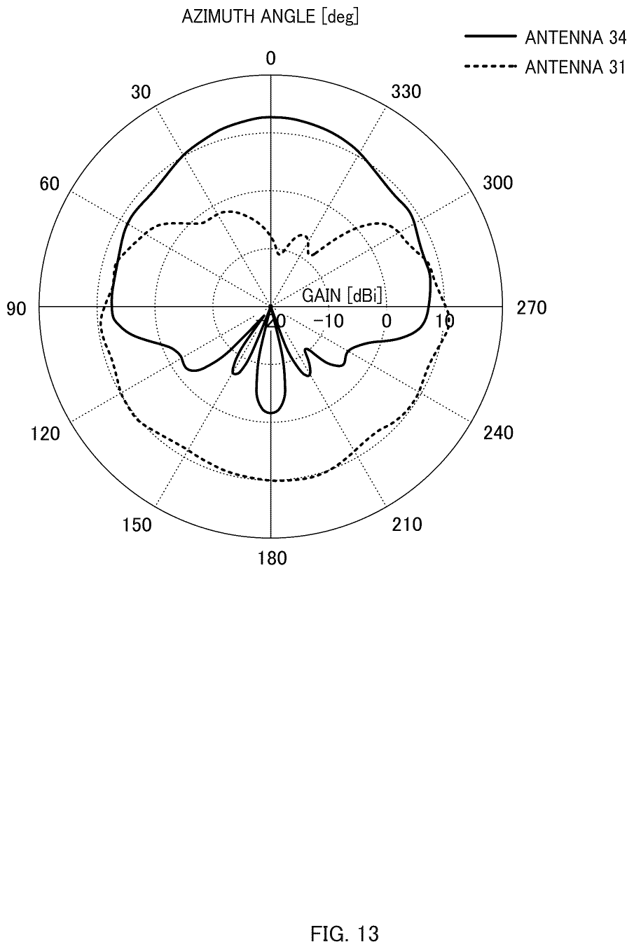

FIG. 13 is a diagram illustrating simulation results of the horizontal directivity of the antennas 31 and 34 installed in the vehicular antenna device 11 at the infinite ground plate. In FIG. 13, the solid line indicates the directivity of the antenna 34 and the dotted line indicates the directivity of the antenna 31. Further, as described above, an azimuth angle of 0° corresponds to the +x direction (forward direction), and an azimuth angle of 90° corresponds to the +y direction (left direction).

As illustrated in FIG. 13, by using the antennas 31 and 34, it is possible to obtain a gain of substantially 10 dBi with respect to the vertically polarized waves in the V2X frequency band over the front, rear, right, and left directions of the vehicular antenna device 10 at the infinite ground plate.

In particular, when comparing the directivity (solid line) of the antenna 30 in FIG. 10 and the directivity (solid line) of the antenna 34 in FIG. 13, the antenna 34 has improved gain in the forward direction and right-left direction as compared to the antenna 30. Accordingly, when using the antennas 31 and 34, very good directivity can be obtained in the horizontal plane. The directivity of the antenna 31 in both FIGS. 10 and 13 is substantially the same.

As such, the vehicular antenna device 11 includes the parasitic element 35 configured to operate as a director and the parasitic element 36 configured to operate as a reflector. Accordingly, in the vehicular antenna device 11, the gain in front of the antenna 34 (+x direction) particularly increases, and the directivity is also improved.

### <<Regarding Directivity of Vehicular Antenna Device X to be Compared>>

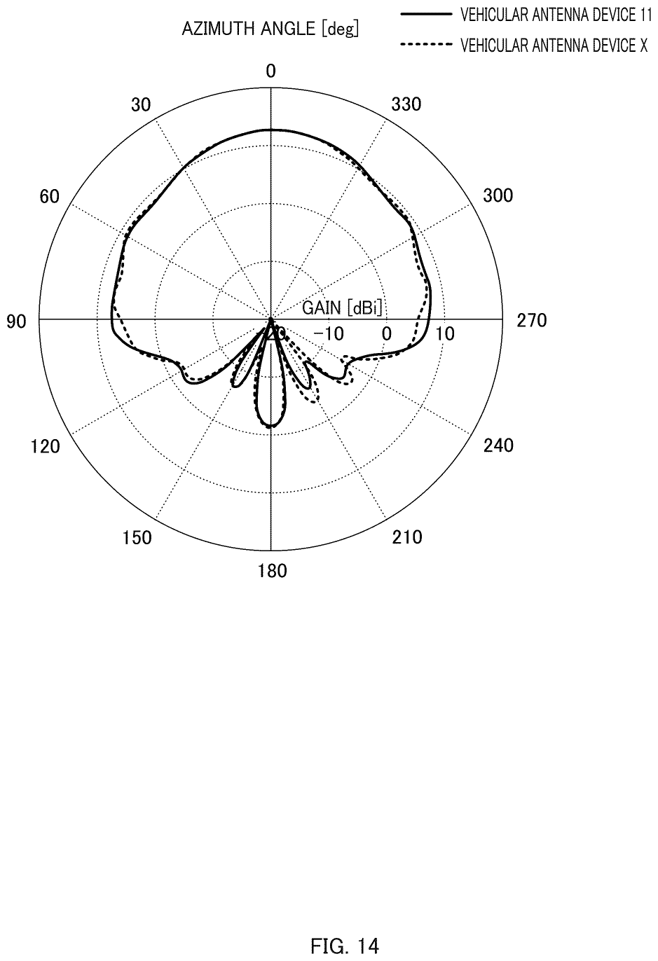

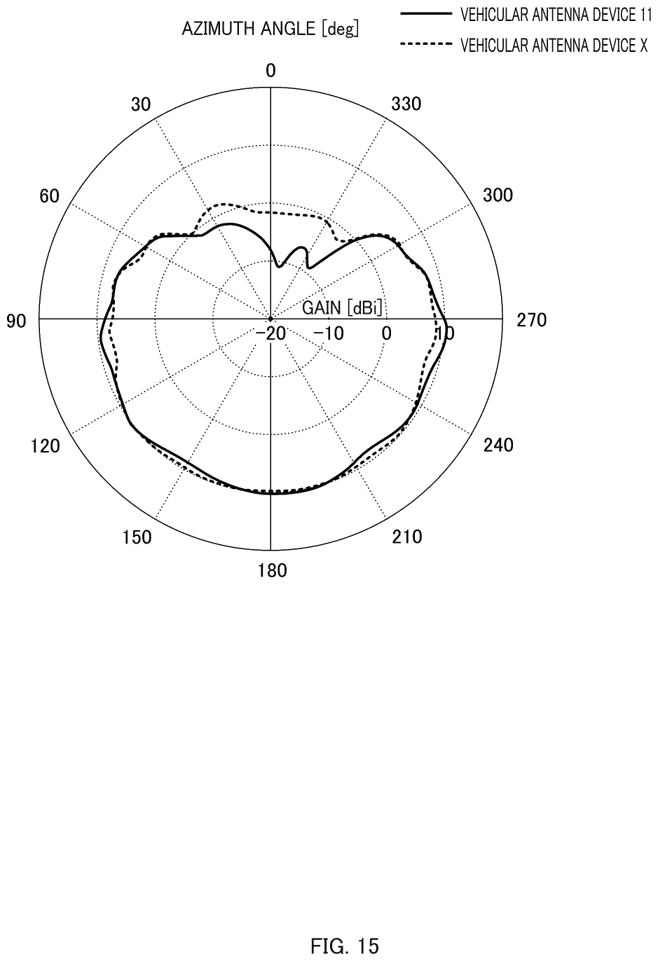

FIG. 14 is a diagram illustrating the gain in the horizontal plane of the antenna 34 in each of the vehicular antenna device 11 and the vehicular antenna device X (described later). FIG. 15 is a diagram illustrating the gain in the horizontal plane of the antenna 31 in each of the vehicular antenna device 11 and the vehicular antenna device X. Here, the “vehicular antenna device X” is a device to be compared having a configuration obtained by excluding the GNSS antenna 32 and the DAB antenna 33 from the configuration of the vehicular antenna device 11 of FIG. 11. The difference between the vehicular antenna device 11 and the vehicular antenna device X is only the GNSS antenna 32 and DAB antenna 33, and thus the vehicular antenna device X is not illustrated here for convenience.

As illustrated in FIG. 14, there is no significant difference between the directivity (solid line) of the antenna 34 of the vehicular antenna device 11 and the directivity (dotted line) of the antenna 34 of the vehicular antenna device X. Further, as illustrated in FIG. 15, there is no significant difference between the directivity (solid line) of the antenna 31 of the vehicular antenna device 11 and the directivity (dotted line) of the antenna 31 of the vehicular antenna device X, except for a certain range (range of azimuth angles of 30° to 330°). The antenna 31 mainly supports vertically polarized waves in the −x direction (within a range of ±120° around an azimuth angle of 180°). Thus, even if the gain in the range of azimuth angles of 30° to 330° in the gain of the antenna 31 decreases, the characteristics of the antenna 31 are not affected.

As such, in the vehicular antenna device 11 of an embodiment of the present disclosure, with each of the antennas 31 and 34 being arranged at a position close to the case 22, it is possible to obtain good directivity while preventing the antennas 31 and 34 from being affected by other antennas.

Further, in an embodiment of the present disclosure, the antennas 34 and 31 carry out at least one of receiving or transmitting signals in the same frequency band. Moreover, between the antenna 34 and antenna 31, antennas (here, antennas 32 and 33) of frequency bands lower than the frequency bands supported by the antennas 34 and 31 are arranged. Antennas supporting higher frequency bands are more likely to be affected by the case 22, and conversely, antennas supporting lower frequency bands are less likely to be affected by the case 22. Thus, in an embodiment of the present disclosure, the antennas 34 and 31 are arranged on the outer side of the vehicular antenna device 11, and the antennas 32 and 33 are arranged on the inner side of the vehicular antenna device 11. By arranging the antennas as such, it is possible to improve the performance of each antenna.

Furthermore, the height of the antenna 34 is lower than the height of the antenna 31. Accordingly, in the vehicular antenna device 11, by setting the antenna system of the antennas 34 and 31 according to the front and rear positions at which the antennas are to be arranged, and to the space inside the case 22, it is possible to reduce the size of the vehicular antenna device 11 while securing the directivity and gain of the antennas 34 and 31.

In an embodiment of the present disclosure, the antennas 34 and 31, which support the same frequency band, have different antenna systems, respectively. However, the antennas 34 and 31 are not limited to the case of having different antenna systems, and may have the same antenna system depending on design requirements. As such, when the vehicular antenna device 11 includes a plurality of antennas arranged, it may include a combination of antennas having the same antenna system, or may include antennas having antenna systems that are all different.

Further, the antennas 34 and 31 are arranged substantially in the center of the vehicular antenna device 11 in the width direction (Y direction). Thus, the directivity of the antennas 34 and 31 can be symmetrical with respect to the X-axis, and adjustment and control so as to provide directivity in the front-rear direction (X direction) is facilitated.

In an embodiment of the present disclosure, the antenna 32 is arranged such that the height of the top surface thereof is lower than the top end of the antenna 34. In this case, the electrical properties of the antenna 34 are improved. The antenna 32 may be arranged such that the height of the top surface is higher than the top end of the antenna 34. In this case, the electrical properties of the antenna 32 are improved. That is, in an embodiment of the present disclosure, the height of the antennas arranged in the vehicular antenna device 11 can be selected depending on the application of design. This can ensure the characteristics of the antennas arranged in the vehicular antenna device 11 without impairing the design of the vehicular antenna device 11, and achieve miniaturization as well.

Further, in an embodiment of the present disclosure, the antennas 34, 31, and 32 are installed at different substrates, respectively. However, at least two or more of the antennas 34, 31, and 32 may be installed at the same substrate. This makes it possible to improve ease of assembly of the antenna.

### <<Correspondence Relationship>>

In the vehicular antenna device 11 of FIG. 11, the antenna 34 corresponds to the “first antenna.” Further, for example, the corner portion P3 of the antenna 34 corresponds to “at least a portion of the first antenna,” and the distance D3 corresponds to the “predetermined distance.”

In addition, for example, the position separated by the distance D3 (i.e., the position of the corner portion P3 of the installed antenna 34) from the position at which the corner portion P3 of the antenna 34 contacts the case 22 corresponds to the “first position.”

### Vehicular Antenna Device 12 (Third Embodiment)

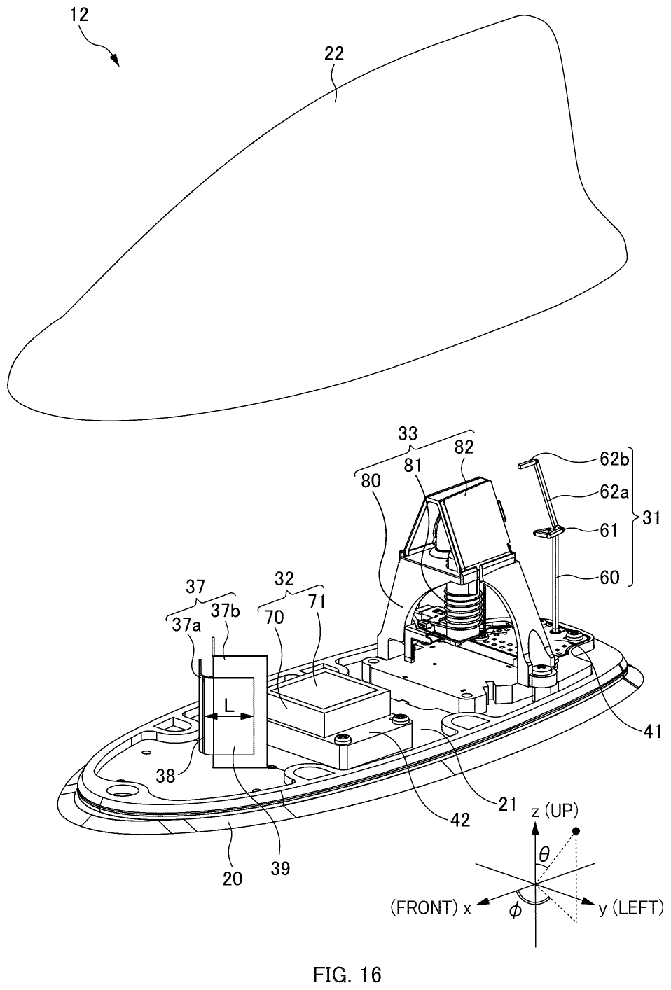

FIG. 16 is a diagram for explaining the configuration of the vehicular antenna device 12 of a third embodiment. In the vehicular antenna device 12, an antenna 37 is provided instead of the antenna 30 in the vehicular antenna device 10 of FIG. 1. In the vehicular antenna device 12, the configuration other than the antenna 37 is the same as that of the vehicular antenna device 10, and thus the antenna 37 will be described here.

### <<Antenna 37>>

The antenna 37 is a patch antenna supporting vertically polarized waves in the V2X frequency band, and includes a patch element 37a and a ground conductor plate 37b. The patch element 37a is a member formed by bending a metal plate to have a shape protruding in the +x direction. Specifically, the patch element 37a has an apex portion 38 on the +x side with a predetermined width (length in the y-axis direction), and two inclined portions 39, obtained by bending, toward the −x direction, at the sides of the apex portion 38 on the right and left thereof, respectively.

The distance L from each of the sides of the apex portion 38 on the right and left thereof to the sides at the ends of the inclined portions 39 that are parallel to the sides of the apex portion 38 on the right and left thereof is, for example, 12 mm. This distance L is substantially ¼ (λ/4=12.5 mm) of the wavelength λ of the V2X frequency band. Also, the patch element 37a is provided with a feeding point (not illustrated).

As with the patch element 37a, the ground conductor plate 37b is a member formed by bending a metal plate to have a shape protruding in the +x direction. Further, the ground conductor plate 37b of an embodiment of the present disclosure is electrically connected to the metal base 21 so as to function as a ground.

Further, in an embodiment of the present disclosure, for example, a synthetic resin dielectric (not illustrated) is sandwiched between the patch element 37a and the ground conductor plate 37b so as to fill the gap therebetween. Further, the dielectric adheres to each of the patch element 37a and the ground conductor plate 37b with an insulating tape (not illustrated). Thus, the patch element 37a is fixed to the ground conductor plate 37b via the dielectric. Even when such an antenna 37 is used, it is possible to receive vertically polarized waves in the V2X frequency band.

### <<Installation Position of Antenna 37>>

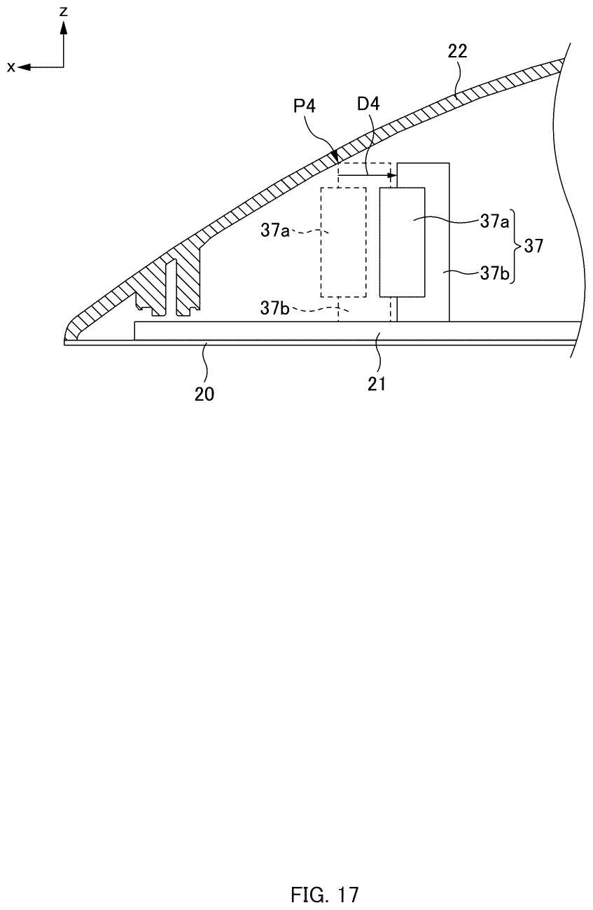

FIG. 17 is a diagram for explaining the position of the front antenna 37 in the vehicular antenna device 12. FIG. 17 also is a cross sectional view of the case 22 in the same manner as in FIG. 8 described above.

In an embodiment of the present disclosure, the position of the antenna 37 is determined such that a portion of the antenna 37 is at the desired position described above. Specifically, in an embodiment of the present disclosure, for example, the antenna 37 (corner portion P4) is provided at a position separated rearward by a distance D4 from the position at which the corner portion P4 above the ground conductor plate 37b of the antenna 37 contacts the case 22. Here, the distance D4 is a distance (e.g., 5 mm) shorter than substantially 75 mm, which is three-halves of the V2X wavelength (3λ/2). In FIG. 17, the dotted line indicates a virtual state in which the corner portion P3 of the ground conductor plate 37b of the antenna 37 is in contact with the case 22.

By installing the antenna 37 at such a position, the vehicular antenna device 12 can obtain good directivity (in particular, forward directivity) in the V2X frequency band.

### <<Correspondence Relationship>>

In the vehicular antenna device 12 of FIG. 16, the antenna 37 corresponds to the “first antenna.” Further, for example, the corner portion P4 of the antenna 37 corresponds to “at least a portion of the first antenna,” and the distance D4 corresponds to the “predetermined distance.”

In addition, for example, the position separated by the distance D4 (i.e., the position of the corner portion P4 of the installed antenna 37) from the position at which the corner portion P4 of the antenna 37 contacts the case 22 corresponds to the “first position.”

### Vehicular Antenna Device 13 (Fourth Embodiment)

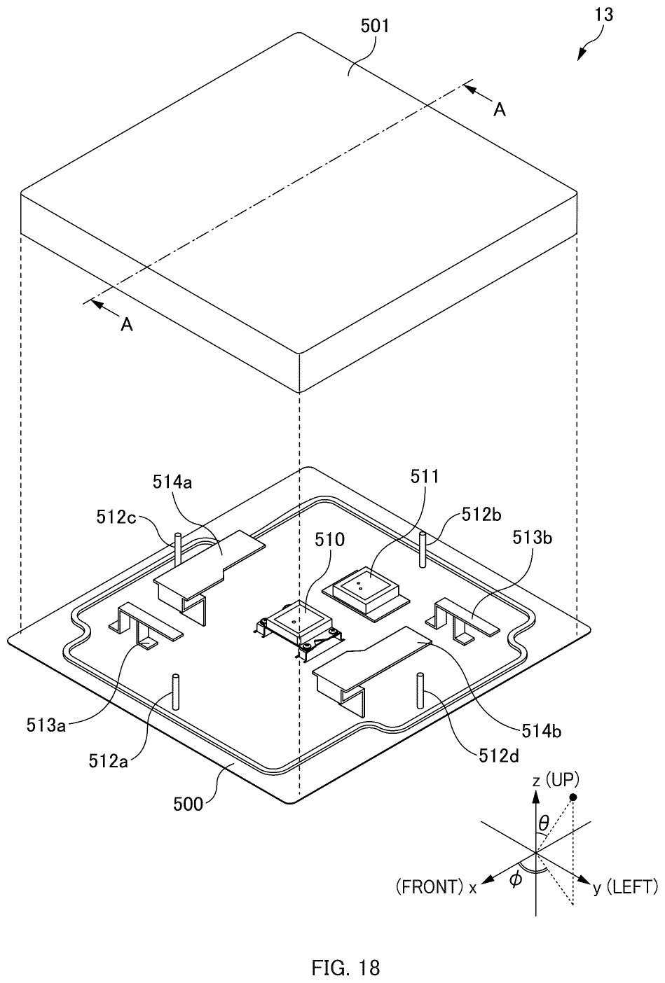

FIG. 18 is a diagram for explaining the configuration of the vehicular antenna device 13 of a fourth embodiment. The vehicular antenna device 13 is housed, for example, in a cavity between a roof panel (not illustrated) of the vehicle and a roof lining in the ceiling surface of the vehicle interior. The vehicular antenna device 13 is a compound antenna device including a plurality of antennas operating in different frequency bands, and includes a metal base 500, a case 501, and antennas 510 to 514.

Although the details will be described later, the antenna 512 is a collective term for the antennas 512a to 512d, and the antenna 513 is a collective term for the antennas 513a and 513b. Further, the antenna 514 is a collective term for the antennas 514a and 514b.

The metal base 500 is a substantially quadrilateral metal plate used as a ground common to the antennas 510 to 514, and is installed on the roof lining of the vehicle. Further, the metal base 500 is a thin plate extending over the front, rear, right, and left directions.

The case 501 is a box-shaped member, and one face on the lower side of its six faces is open. Further, since the case 501 is made of an insulating resin, radio waves can pass through the case 501. Then, the case 501 is mounted to the metal base 500 such that the opening on the lower side of the case 501 will be closed by the metal base 500. Thus, the antennas 510 to 514 are accommodated in the space (accommodation space) inside the case 501.

The antenna 510 is, for example, a patch antenna compatible with the SDARS system, and receives left-hand circularly polarized waves in the 2.3 GHz band. The antenna 510 is installed near the center of metal base 500.

The antenna 511 is, for example, a planar antenna compatible with GNSS, and receives radio waves in the 1.5 GHz band from an artificial satellite. The antenna 511 is installed in the rear (−x direction) of the antenna 510.

The antenna 512 is an antenna supporting vertically polarized waves in the V2X frequency band, and is similar to the antenna 30 of the vehicular antenna device 10 of FIG. 1. Each of the antennas 512a to 512d is arranged around the antenna 510. Specifically, the antennas 512a and 512b are respectively arranged on the front and rear sides of the antenna 510. Moreover, the antennas 512c and 512d are respectively arranged on the left and right sides of the antenna 510.

In an embodiment of the present disclosure, the antenna 512a mainly supports vertically polarized waves from the front (+x direction), and the antenna 512b mainly supports vertically polarized waves from the rear (−x direction). Further, the antenna 512c mainly supports vertically polarized waves from the left side (+y direction), and the antenna 512d mainly supports vertically polarized waves from the right side (−y direction). The vehicular antenna device 13 includes a plurality of antennas 512a to 512d with different directivities, thereby being able to receive desired radio waves using a diversity system. Details of the installation positions of the antennas 510a to 510d will be described later.

The antennas 513a and 513b are, for example, telematics antennas compatible with the fifth-generation mobile communication system. The antennas 513a and 513b transmit and receive radio waves in the Sub-6 band defined by the standards of the fifth-generation mobile communication system.

The antennas 514a and 514b are, for example, telematics antennas compatible with Long Term Evolution (LTE) and fifth-generation mobile communication systems. The antenna 514 transmits and receives radio waves in the 700 MHz to 2.7 GHz frequency band defined by the LTE standards. Further, the antenna 514 also transmits and receives radio waves in the Sub-6 band defined by the standards of the fifth-generation mobile communication system, that is, frequency bands from 3.6 GHz to less than 6 GHz.

The communication standards and frequency bands applicable to the antennas 510 to 514 are not limited to those described above, and other communication standards and frequency bands may be used.

### <<Installation Position of Antenna 512>>

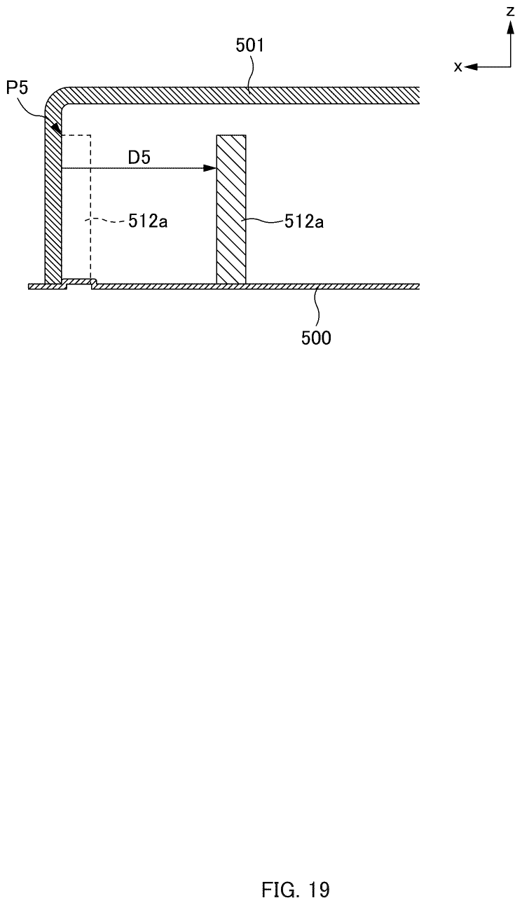

FIG. 19 is a diagram for explaining the installation position of the antenna 512a. Specifically, FIG. 19 is an enlarged diagram of the vicinity of the installation position of the antenna 512a in the cross section of the vehicular antenna device 13 taken along line A-A of FIG. 18.

In an embodiment of the present disclosure, the position of the antenna 512a is determined such that a portion of the antenna 512a is at the desired position described above. Specifically, in an embodiment of the present disclosure, for example, the rod-shaped antenna 512a (tip portion P5) is provided at a position separated rearward by a distance D5 from the position at which the tip portion P5 of the antenna 512a contacts the case 501. Here, the distance D5 is a distance (e.g., 5 mm) shorter than substantially 75 mm, which is three-halves of the V2X wavelength (3λ/2). In FIG. 19 as well, the dotted line indicates a virtual state in which the tip portion P5 of the antenna 512a is in contact with the case 501.

By installing the antenna 512a at such a position, forward directivity in the V2X frequency band can be improved. Although the antenna 512a has been described here, other V2X antennas 512b to 512d are also installed at desired positions, as with the antenna 512a. Accordingly, the vehicular antenna device 13 can improve the directivity in the four directions of front, rear, right, and left in the V2X frequency band.

The vehicular antenna device 13 in FIG. 18 includes four V2X antennas 512a to 512d, but is not limited to this. For example, as V2X antennas, only two antennas 512a and 512b in the front-rear direction may be provided, or only two antennas 512c and 512d in the right-left direction may be provided. Even in such cases, the directivity of the provided antennas can be improved.

### <<Correspondence Relationship>>

In the vehicular antenna device 13 of FIG. 18, for example, the antenna 512a corresponds to the “first antenna” and the antenna 512b corresponds to the “second antenna.” Further, for example, the antenna 510 corresponds to the “third antenna.”

Furthermore, for example, the tip portion P4 of the antenna 512a corresponds to “at least a portion of the first antenna,” and the distance D4 corresponds to the “predetermined distance.” Further, the +x direction corresponds to the “first direction,” and the −x direction corresponds to the “second direction opposite to the first direction.”

In addition, for example, the position separated by the distance D4 (i.e., the position of the tip portion P4 of the installed antenna 512a) from the position at which the tip portion P4 of the antenna 512a contacts the case 501 corresponds to the “first position.” In this case, the position corresponding to the tip portion of the antenna 512b corresponds to the “second position.”

### Vehicular Antenna Device 14 (Fifth Embodiment)

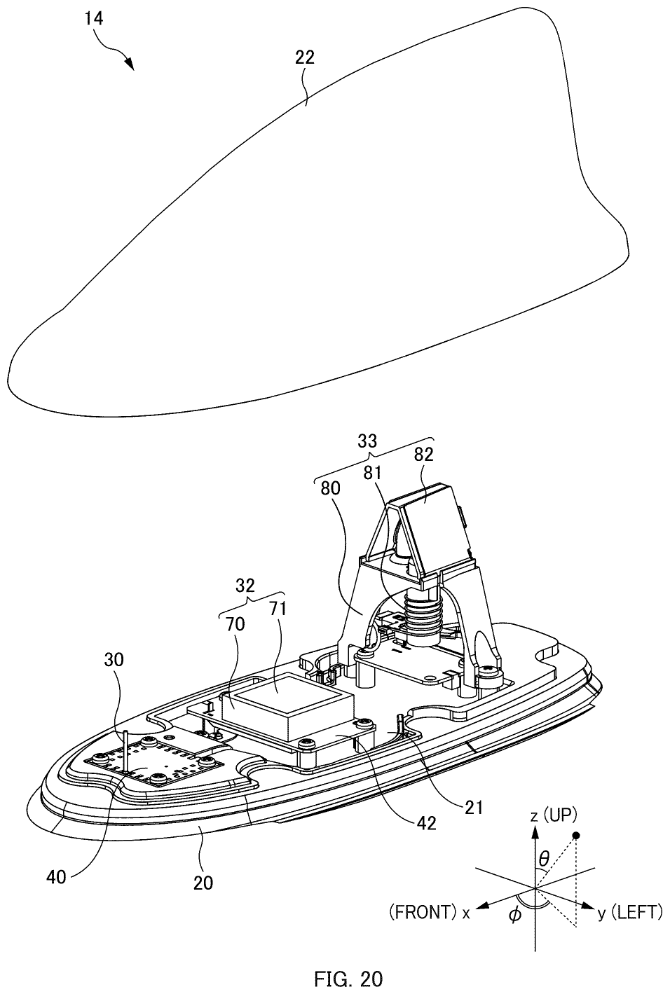

FIG. 20 is a diagram illustrating the configuration of the vehicular antenna device 14 as a fifth embodiment of the present disclosure. As compared to the vehicular antenna device 10 (FIG. 1) which is the first embodiment described above, the vehicular antenna device 14 relates to the antenna supporting radio waves in the V2X frequency band, and includes only the antenna 30. In other words, the vehicular antenna device 14 excludes the antenna 31 or substrate 41, as opposed to the vehicular antenna device 10 of the first embodiment. The vehicular antenna device 14 has the same configuration as the vehicular antenna device 10, except that it excludes the antenna 31 or substrate 41. Further, in the vehicular antenna device 14 illustrated in FIG. 20, the same components as of the vehicular antenna device 10 are given the same reference numerals as of the vehicular antenna device 10. Furthermore, FIG. 20 is a perspective view of the vehicular antenna device 14 with the case 22 removed in the zenith direction (upward direction), as in FIG. 1.

In the vehicular antenna device 14 as well, the antenna 30 preferably has good directivity within a certain angular range with the front as the center (e.g., φ=±1200 with reference to 0°). That is, the antenna 30 preferably has a small gain deviation over a wide angular range (e.g., the range of φ=±120°). Even in this case, as with the case illustrated in FIG. 8 described above, by setting the position of the antenna 30 at a desired position, it is possible to reduce the gain deviation in a wide angular range, thereby being able to improve the directivity.

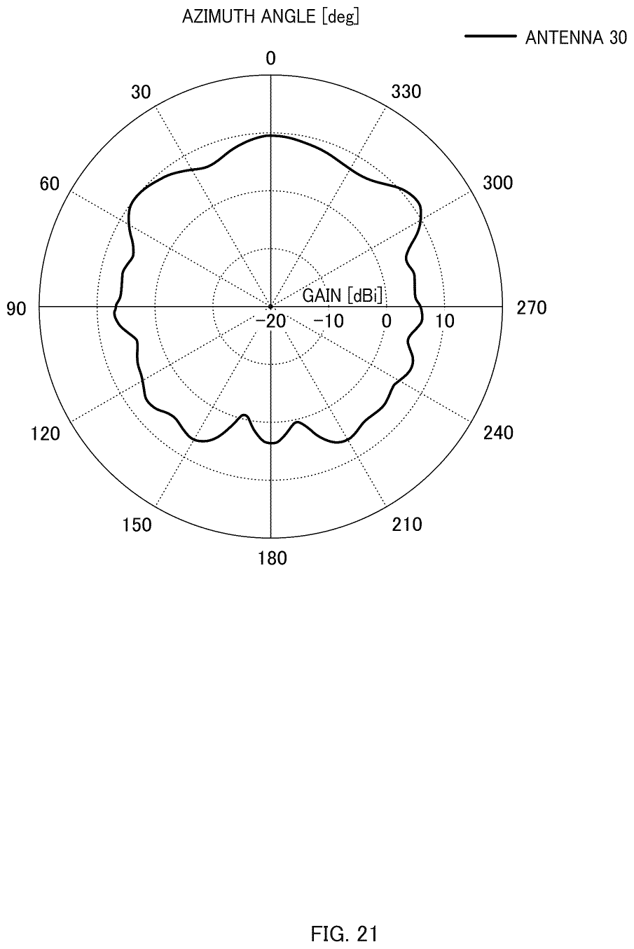

FIG. 21 is a diagram illustrating the horizontal directivity of the antenna 30 installed at the vehicular antenna device 14. Further, as described above, an azimuth angle of 0° corresponds to the +x direction (forward direction), and an azimuth angle of 90° corresponds to the +y direction (left direction). FIG. 21 provides simulation results indicating the horizontal directivity of the antenna 30 when an infinite ground plate is used. As illustrated in FIG. 21, in an embodiment of the present disclosure, the vehicular antenna device 10 can achieve a gain slightly smaller than 10 dBi with respect to vertically polarized waves in the V2X frequency band over the front, rear, right, and left directions on the infinite ground plate, although there are some exceptions. As such, when the antenna 30 is used, good directivity can be obtained in the horizontal plane.

In the fifth embodiment described above, the vehicular antenna device 14 relates to the antenna supporting to radio waves in the V2X frequency band, and includes only the front antenna 30. However, although not illustrated and verified, the vehicular antenna device may relate to the antenna supporting to radio waves in the V2X frequency band, and include only the rear antenna 31. Even in this case, by setting the position of the antenna 31 at a desired position, it is possible to reduce the gain deviation in a wide angular range, thereby being able to improve the directivity.

### Others

The following describes other features of the vehicular antenna devices of the above-described embodiments and vehicular antenna devices of embodiments other than the above-described embodiments.

### Periphery of Substrate 41 of Vehicular Antenna Device 10 First Embodiment

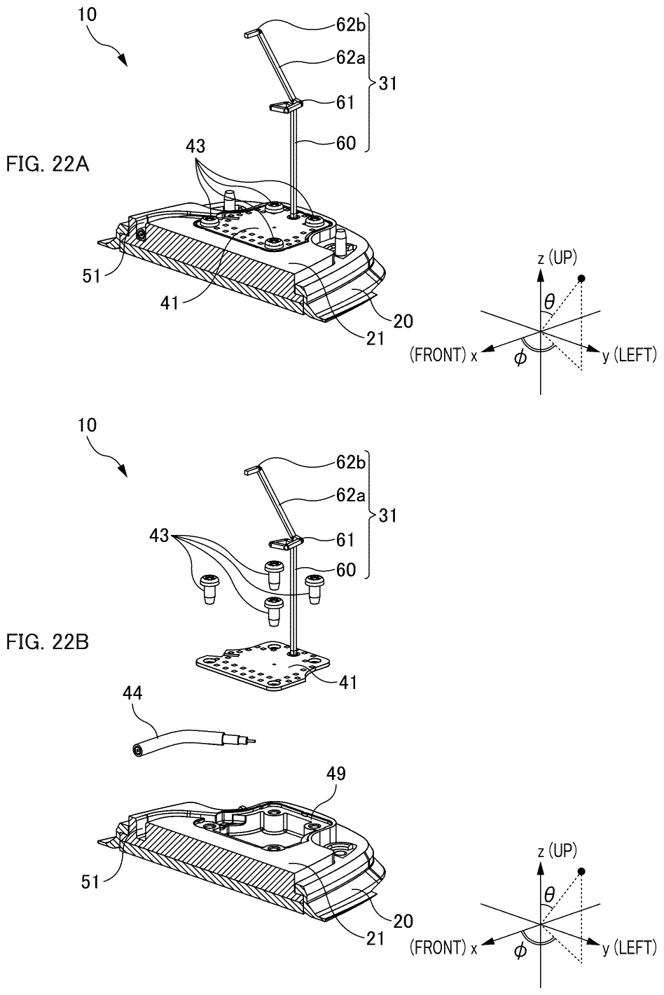

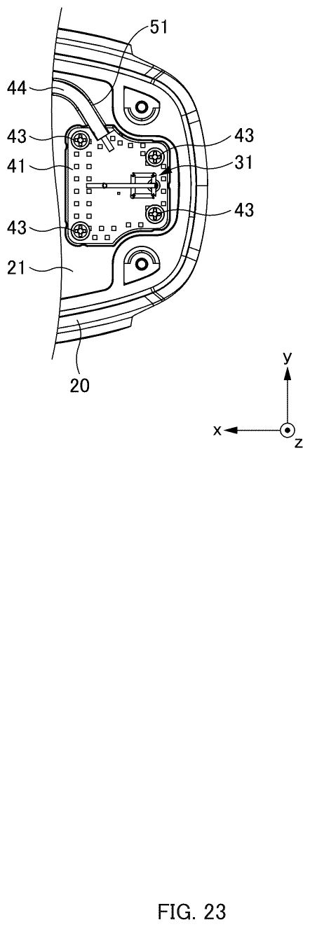

FIGS. 22A and 22B are each a perspective view illustrating the periphery of the substrate 41 of the vehicular antenna device 10. FIG. 22A is a perspective view in which the substrate 41 and the like are mounted to the metal base 21, and FIG. 22B illustrates an exploded perspective view in which the substrate 41 and the like are removed from the metal base 21. FIG. 23 is a plan view illustrating the periphery of the substrate 41 of the vehicular antenna device 10.

The antenna 31 of the vehicular antenna device 10 described above is installed at the substrate 41 mounted to the rear portion of the metal base 21. Here, the antenna 31 is electrically connected to the substrate 41 at a feeder (not illustrated). The antenna 31 is connected to the coaxial cable 44 illustrated in FIG. 22B through a matching circuit (not illustrated) implemented at the substrate 41. The substrate 41 may be implemented with a circuit element(s) and/or an electronic component(s) other than the matching circuit.

Here, the outer periphery of the substrate 41 on the matching circuit side (lower side) is electrically connected to the ground on the antenna 31 side via a through hole(s), a via-hole(s), and/or the like. In addition, the outer periphery of the substrate 41 on the matching circuit side is subjected to conductive surface treatment such as solder leveling or gold plating.

Further, in the metal base 21, a receiving portion 49 and a cable accommodating portion 51 are formed, as illustrated in FIGS. 22A to 23.

The receiving portion 49 is, as illustrated in FIG. 22B, a receiving structure (recessed portion) to receive the substrate 41, formed to contact the outer periphery of the substrate 41 on the matching circuit side (lower side). As illustrated in FIGS. 22A and 22B, the substrate 41 is assembled to the metal base 21 using screws 43, so that the substrate 41 is held while a pressure is being applied thereto. In addition, the receiving portion 49 of the metal base 21 contacts the outer periphery of the substrate 41 on the matching circuit side. This makes it possible to electrically connect between the ground on the antenna 31 side and the metal base 21 throughout the entire outer periphery of the substrate 41 on the matching circuit side.

Further, the receiving portion 49 is formed such that the substrate 41 is flush with the metal base 21 when the substrate 41 is assembled to the metal base 21. This makes it possible to suppress generation of radiation wave sources generated at the edge of the substrate 41 and reduce the influence of the shape of the substrate 41 on the electrical properties of the antenna 31.

Applying a conductive surface treatment to the contact portion between the substrate 41 and the screw 43 on the substrate 41 side makes it possible to electrically connect between the contact portion and the metal base 21. At this event, the interval between the screws 43 is preferably equal to or less than half the wavelength of the frequency used by the antenna 31.

Furthermore, as illustrated in FIGS. 22B and 23, the cable accommodating portion 51 is a recessed portion to accommodate the coaxial cable 44 connected to the substrate 41. The coaxial cable 44 is held by the metal base 21, by being accommodated in the cable accommodating portion 51. This improves the holding of the coaxial cable 44. Further, the coaxial cable 44 is located on the lower side relative to the substrate 41. In addition, a portion of the coaxial cable 44 (e.g., two-thirds of the diameter of the coaxial cable 44) may be embedded in the cable accommodating portion 51, the conductive wall of the metal base 21, or the like, such that the coaxial cable 44 is positioned below the upper surface of the metal base 21 or the substrate 41. This makes it possible to suppress the reduction in the gain of the antenna 31 and the effects on the directivity due to leakage current of the coaxial cable 44.

### Antenna 31 and Case 22 of Vehicular Antenna Device 10 (First Embodiment)

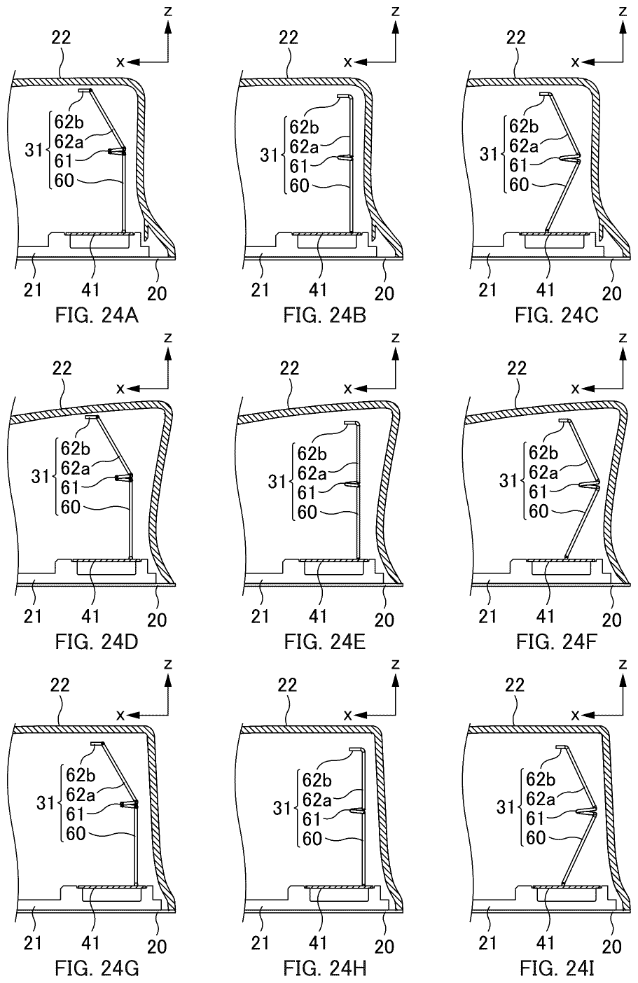

FIGS. 24A to 24I are each a diagram for explaining another example of the antenna 31 and the case 22. FIGS. 24A to 24C illustrate examples in which the case 22 having a first case shape is combined with the antennas 31 having a first antenna shape to a third antenna shape. In addition, FIGS. 24D to 24F illustrate examples in which the case 22 having a second case shape is combined with the antennas 31 having the first antenna shape to third antenna shape. In addition, FIGS. 24G to 24I illustrate examples in which the case 22 having a third case shape is combined with the antennas 31 having the first antenna shape to third antenna shape.

In the vehicular antenna device 10 described above, the shapes of the antenna 31 and the case 22 are not limited to those illustrated in FIG. 9. The antenna 31 illustrated in FIG. 9 has a shape (hereinafter referred to as “first antenna shape”) including a linear portion 62a that is inclined towards the +x direction as it goes upward (+z direction) from the annular portion 61. However, the antenna 31 may have a linear shape along the z direction (hereinafter referred to as “second antenna shape”).

Additionally, the antenna 31 may have a shape (hereinafter referred to as the “third antenna shape”) including a linear portion 60 that is inclined towards the +x direction as it goes downward (−z direction), and a linear portion 62a that is inclined towards the +x direction as it goes upward (+z direction), with the annular portion 61 as the boundary. In other words, the linear portion 62a connected to one end portion of the annular portion 61 is inclined in the +x direction as it goes upward (+z direction) from the connection point with the annular portion 61. Moreover, the linear portion 60 connected to the other end portion of the annular portion 61 is inclined towards the +x direction as it goes downward (−z direction) from the connection point with the annular portion 61. The third antenna shape is such a shape in which one end portion and the other end portion of the annular portion 61 are closest to the case 22.

In addition, the case 22 illustrated in FIG. 9 has a shape with an inner wall along the z direction (hereinafter referred to “first case shape”). However, the case 22 may also have a shape including an inner wall that is inclined toward the −x direction as it goes upward (+z direction), as illustrated in FIGS. 24D to 24F (hereinafter referred to as “second case shape”). Furthermore, the case 22 illustrated in FIG. 9 has a shape in which the wall on the antenna base 20 side including a bulge that protrudes inward (toward the antenna 31 side). However, the shape of the wall of the case 22 may be more linear than the first case shape, as illustrated in FIGS. 24G to 24I.

FIGS. 24A to 24I illustrate examples of combinations of the antenna 31 with the first antenna shape to third antenna shape and the case 22 with the first case shape to third case shape, as described above. The antenna 31 is not limited to the cases illustrated in FIGS. 24A to 24I, for example, it may have a shape including a linear portion 62a that is inclined toward the −x direction as it goes upward (+z direction) from the annular portion 61. Additionally, the antenna 31 may have a shape including a linear portion 62a that is inclined toward the −x direction as it goes upward (+z direction) and a linear portion 60 that is inclined toward the −x direction as it goes downward (−z direction), with the annular portion 61 as the boundary.

### Antenna 34 of Vehicular Antenna Device 11 (Second Embodiment)

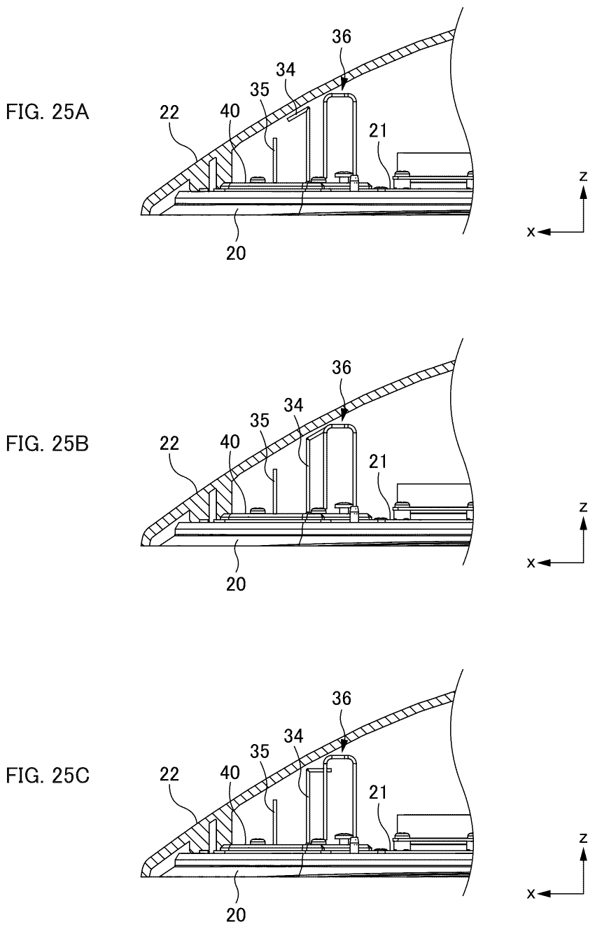

FIGS. 25A to 25C are each a diagram for explaining another example of the antenna 34. FIG. 25A illustrates an example of the antenna 34 having the first antenna shape, FIG. 25B illustrates an example of the antenna 34 having the second antenna shape, and FIG. 25C illustrates an example of the antenna 34 having the third antenna shape.

The antenna 34 illustrated in FIGS. 11 and 12 is mounted at the front surface of the substrate 40 so as to be substantially vertical thereto. However, the shape of the antenna 34 may be other than those illustrated in FIGS. 11 and 12.

The antenna 34 may have its tip bent along the case 22 as illustrated in FIGS. 25A and 25B. The antenna 34 having the first antenna shape illustrated in FIG. 25A has its tip bent in the +x direction, and the antenna 34 having the second antenna shape illustrated in FIG. 25B has its tip bent in the −x direction.

Moreover, the angle at which the antenna 34 is bendable does not have to be an angle at which the tip is bent along the case 22 as illustrated in FIGS. 25A and 25B, but may be in a direction of 90°, as in the antenna 34 with the third antenna shape illustrated in FIG. 25C. The angle at which the antenna 34 is bendable may be any of acute, right, or obtuse angles, as long as the antenna 34 does not contact the case 22 or other antennas.

### Periphery of Substrate 40 of Vehicular Antenna Device 11 Second Embodiment

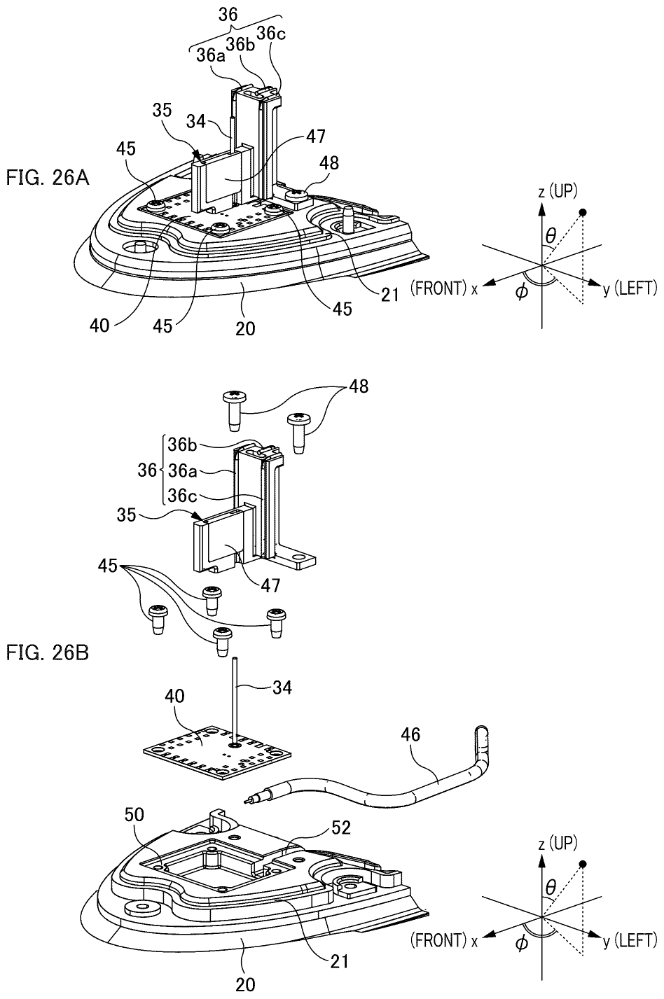

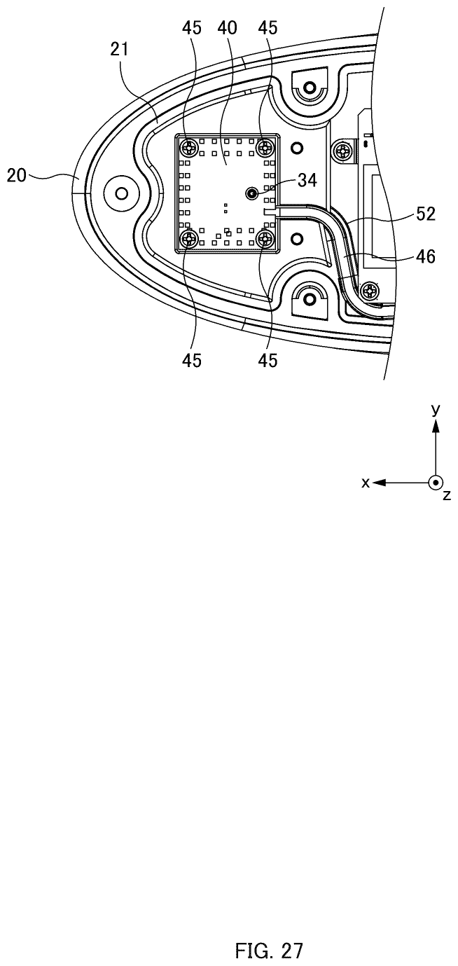

FIGS. 26A and 26B are each a perspective view illustrating the periphery of the substrate 40 of the vehicular antenna device 11. FIG. 26A illustrates a perspective view in which the substrate 40 and the like are mounted to the metal base 21, and FIG. 26B illustrates an exploded perspective view in which the substrate 40 and the like are removed from the metal base 21. FIG. 27 is a plan view illustrating the periphery of the substrate 40 of the vehicular antenna device 11.

The antenna 34 of the vehicular antenna device 11 described above is installed at the substrate 40 mounted to the front portion of the metal base 21. Here, the antenna 34 is electrically connected to the substrate 40 at a feeder (not illustrated). The antenna 34 is connected to the coaxial cable 46 illustrated in FIG. 26B through a matching circuit (not illustrated) implemented at the substrate 40. The substrate 40 may be implemented with a circuit element(s) and/or an electronic component(s) other than the matching circuit.

Here, the outer periphery of the substrate 40 on the matching circuit side (lower side) is electrically connected to the ground on the antenna 34 side via a through hole(s), a via-hole(s), and/or the like. In addition, the outer periphery of the substrate 40 on the matching circuit side is subjected to conductive surface treatment such as solder leveling or gold plating.

Further, in the metal base 21, a receiving portion 50 and a cable accommodating portion 52 are formed, as illustrated in FIGS. 26B and 27.

The receiving portion 50 is, as illustrated in FIG. 26B, a receiving structure (recessed portion) to receive the substrate 40, formed to contact the outer periphery of the substrate 40 on the matching circuit side (lower side). As illustrated in FIGS. 26A and 26B, the substrate 40 is assembled to the metal base 21 using screws 45, so that the substrate 40 is held while a pressure is being applied thereto. In addition, the receiving portion 50 of the metal base 21 contacts the outer periphery of the substrate 40 on the matching circuit side. This makes it possible to electrically connect between the ground on the antenna 34 side and the metal base 21 throughout the entire outer periphery of the substrate 40 on the matching circuit side.

Further, the receiving portion 50 is formed such that the substrate 40 is flush with the metal base 21 when the substrate 40 is assembled to the metal base 21. This makes it possible to suppress the generation of radiation wave sources generated at the edge of the substrate 40 and reduce the influence of the shape of the substrate 40 on the electrical properties of the antenna 34.

Applying a conductive surface treatment to the contact portion between the substrate 40 and the screw 45 on the substrate 40 side makes it possible to electrically connect between the contact portion and the metal base 21. At this event, the interval between the screws 45 is preferably equal to or less than half the wavelength of the frequency used by the antenna 34.

Furthermore, as illustrated in FIGS. 26B and 27, the cable accommodating portion 52 is a recessed portion to accommodate the coaxial cable 46 connected to the substrate 40. The coaxial cable 46 is held by the metal base 21, by being accommodated in the cable accommodating portion 52. This improves the holding of the coaxial cable 46. Further, the coaxial cable 46 is located on the lower side relative to the substrate 40. In addition, a portion of the coaxial cable 46 (e.g., two-thirds of the diameter of the coaxial cable 46) may be embedded in the cable accommodating portion 52, the conductive wall of the metal base 21, or the like, such that the coaxial cable 46 is positioned below the upper surface of the metal base 21 or the substrate 40. This makes it possible to suppress the reduction in the gain of the antenna 34 and the effects on the directivity due to leakage current of the coaxial cable 46.

### <<Holder 47 for Parasitic Elements 35 and 36>>

In the aforementioned vehicular antenna device 11, as illustrated in FIGS. 26A and 26B, the parasitic elements 35 and 36 may be held by the holder 47. The holder 47 for holding the parasitic elements 35 and 36 is made of, for example, a resin and is assembled to the metal base 21 with screws 48. This enables the parasitic elements 35 and 36 to be arranged in a hollow space. In the vehicular antenna device 11 of an embodiment of the present disclosure, the integrally formed holder 47 holds both the parasitic element 35 and the parasitic element 36. This makes it possible to improve ease of assembly of the vehicular antenna device 11. However, a holder to hold the parasitic element 35 and a holder to hold the parasitic element 36 may be formed, separately.

Moreover, as illustrated in FIGS. 26A and 26B, the holder 47 holds at least a portion of the parasitic elements 35 and 36, without covering all of them. This reduces the area of contact between the conductor portions of the parasitic elements 35 and 36 and the resin of the holder 47, thereby being able to suppress the reduction in the gain and change in directivity of the antenna 34. Furthermore, by covering not all of the parasitic elements 35 and 36, it possible to reduce the amount of resin material used for the holder 47, thereby being able to reduce costs.

Although not illustrated, the parasitic elements 35 and 36 are held by the holder 47 such that the lower ends of the parasitic elements 35 and 36 abut against the holder 47. This enables the parasitic elements 35 and 36 to be arranged in a hollow space. That is, it is possible to avoid the parasitic elements 35 and 36 from contacting the metal base 21 and the substrate 40. In addition, a configuration can be such that the parasitic elements 35 and 36 is inserted into the holder 47 from above, thereby being able to improve ease of assembly of the vehicular antenna device 11.

At least a portion of the holder 47 is arranged between the antenna 34 and the case 22. Further, the dielectric constants of the holder 47 and the case 22 may be the same or different. For example, when the holder 47 is made of a material having a low dielectric constant relative to that of the case 22, it is possible to suppress the reduction in the gain of the antenna 34 and the influence on the directivity.

### Vehicular Antenna Device 15 (Sixth Embodiment)

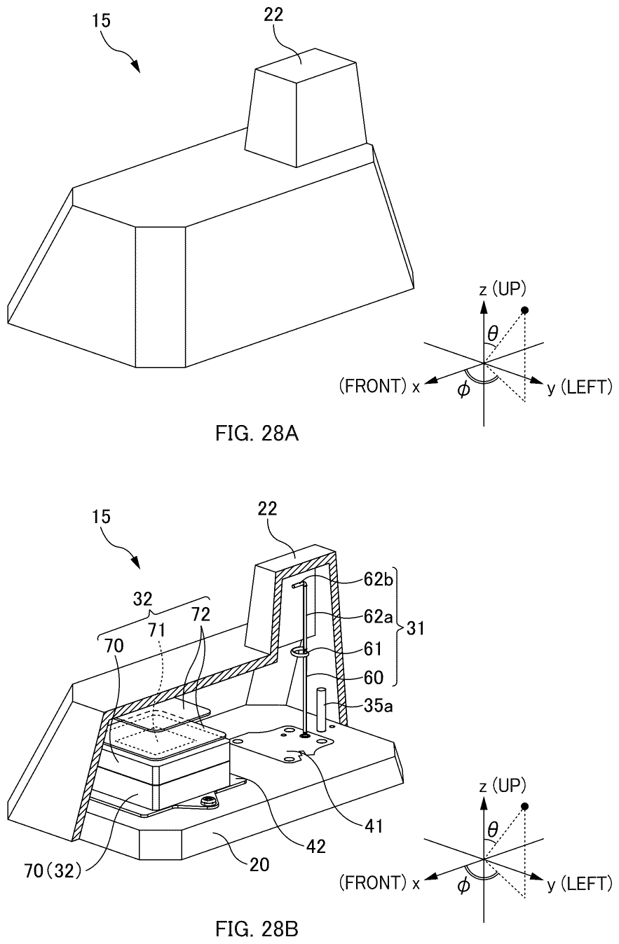

FIGS. 28A and 28B are each a perspective view of the vehicular antenna device 15. FIG. 28A is a perspective view illustrating the appearance of the vehicular antenna device 15 mounted with the case 22, and FIG. 28B is a cross-sectional perspective view illustrating the inside of the vehicular antenna device 15 with a portion of the case 22 removed.

The vehicular antenna device 14 illustrated in FIG. 20 described above relates to the antenna supporting radio waves in the V2X frequency band, and includes only the antenna 30 in the front of the vehicular antenna device 14. However, the vehicular antenna device 15 illustrated in FIGS. 28A and 28B may relate to the antennas supporting radio waves in the V2X frequency band, and include only the antenna 31 in the rear of the vehicular antenna device 15. The following describes the features of the vehicular antenna device 15 that are different from those of the vehicular antenna device 14.

The vehicular antenna device 14 illustrated in FIG. 20 described above includes the antenna 32 supporting GNSS band radio waves and the antenna 33 supporting DAB waveband radio waves, in addition to the antenna 30. However, in the vehicular antenna device 15, as illustrated in FIG. 28B, two antennas 32 are arranged vertically in addition to the antenna 31. For example, the configuration in which these two antennas 32 are arranged vertically may be referred to as a multi-stage patch antenna, multi-layer patch antenna, or stacked patch antenna. In this case, it is possible that the frequency band supported by the first patch antenna is different from the frequency band supported by the second patch antenna. Furthermore, with slots or the like being formed in the patch antenna, a single patch antenna can support multiple frequency bands. Accordingly, with the patch antenna supporting multiple frequency bands being provided in multiple stages, it is possible to support frequencies of multiple frequency bands. In the vehicular antenna device 14 illustrated in FIG. 20, the antenna 32 can also support radio waves of frequency bands different from the 1.5 GHz band in the GNSS band.

In the vehicular antenna device 15, unlike the vehicular antenna device 14, the antenna 32 may have a parasitic element. In the antenna 32 of an embodiment of the present disclosure, as illustrated in FIG. 28B, two parasitic elements 72 are arranged above the radiation element 71 of the antenna 32 in the upper stage. The parasitic elements 72 may be held by a holding member (not illustrated) surrounding the radiation element 71. By including the parasitic elements 72, the antenna 32 can improve the axial ratio, particularly at low elevation angles.

Further, in the vehicular antenna device 15, the case 22 can be designed so as to be close to the antenna 31, as illustrated in FIGS. 28A and 28B. In other words, in the vehicular antenna device 15, the case 22 can be designed so as to be along the shape of the antenna 31. This can further mitigate the influence of the case 22 on the antenna 31.

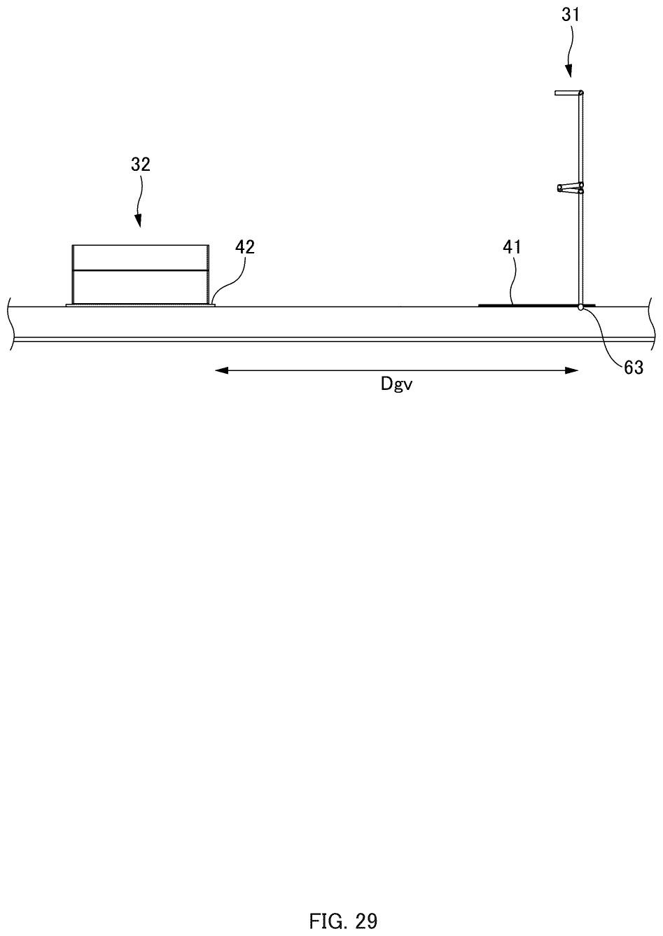

As illustrated in FIG. 29 which will be described later, the antenna 31 includes a circuit 63 configured to suppress the signals of the frequency band supported by the antenna 32. In an embodiment of the present disclosure, the circuit 63 is a filter to suppress the GNSS band signals supported by the antenna 32. In other words, the circuit 63 suppresses the signals of undesired frequency bands in the frequency bands of the radio waves supported by the antenna 31.

This enables the mitigation of the effects on the axial ratio performance of the antenna 32, which supports the GNSS band radio waves, and enables the antenna 31 to be arranged close to antenna 32. However, the circuit 63 is not limited to a filter, but may be a substrate pattern or the like with frequency characteristics of suppressing GNSS band signals. The circuit 63 can be a lumped constant circuit, a distributed constant circuit, or a composite circuit of lumped constant and distributed constant. Furthermore, the antenna 31 may not necessarily include the circuit 63.

The following describes the details of the effects of the circuit 63 included in the antenna 31, using the calculation results of the maximum axial ratio of the antenna 32.

FIG. 29 is an explanatory diagram of the separation distance Dgv between the antenna 31 and antenna 32.

The separation distance Dgv is the separation distance in the horizontal direction between the antenna 31 and the antenna 32 in a side view of the model as illustrated in FIG. 29. Here, the maximum axial ratio of the antenna 32 with varying separation distance Dgv is calculated for both the model in which the antenna 31 excludes the circuit 63 and the model in which the antenna 31 includes the circuit 63.

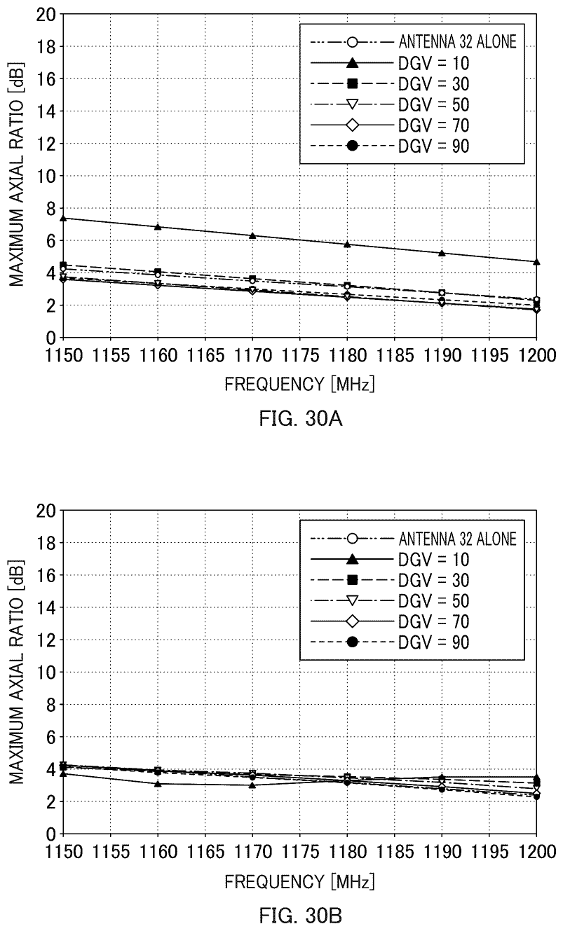

FIGS. 30A and 30B are each a graph illustrating an example of the maximum axial ratio at an elevation angle of 90° when the separation distance Dgv is changed. FIG. 30A is a graph when the antenna 31 excludes the circuit 63, and FIG. 30B is a graph when the antenna 31 include the circuit 63.

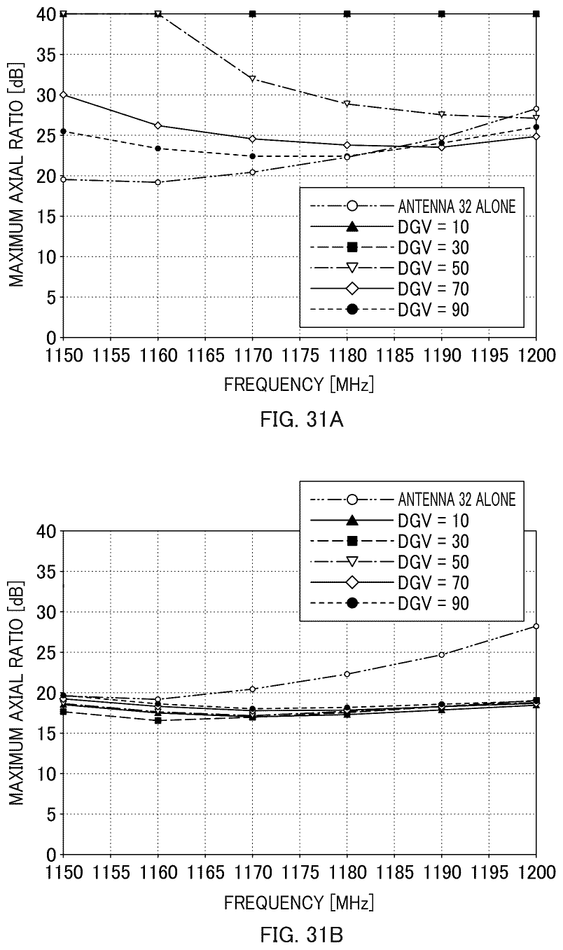

Further, FIGS. 31A and 31B are each a graph illustrating an example of the maximum axial ratio at an elevation angle of 10° when the separation distance Dgv is changed. FIG. 31A is a graph when the antenna 31 excludes the circuit 63, and FIG. 31B is a graph when the antenna 31 includes the circuit 63.

FIGS. 30A, 30B, 31A, and 31B give the calculation results of the maximum axial ratio of the antenna 32 when the separation distance Dgv between the antenna 31 and antenna 32 is changed to 10 mm, 30 mm, 50 mm, 70 mm, and 90 mm, using symbols such as ▴ and ▪ on the lines. These symbols such as ▴ and ▪ on the lines indicate the positions of the vertical axis values corresponding to the horizontal axis values, and they are given symbols such as ▴ and ▪, for convenience to distinguish thereamong. Further, in FIGS. 30 A, 30B, 31A, and 31B, the calculation results of the model including only the antenna 32 (the model without antenna 31) are given as reference values.

As illustrated in FIGS. 30A and 31A, when the antenna 31 excludes the circuit 63, the smaller the separation distance Dgv, the worse the axial ratio of the antenna 32. In contrast, as illustrated in FIGS. 30B and 31B, with the antenna 31 including the circuit 63, the axial ratio of the antenna 32 is improved even when the separation distance Dgv is small. In other words, with the antenna 31 including the circuit 63, the effects on the performance of the axial ratio of antenna 32 can be mitigated, and the antenna 31 can be arranged close to the antenna 32.

### <<Correspondence Relationship>>

In the vehicular antenna device 15 of FIGS. 28A and 28B, the antenna 31 corresponds to the “first antenna” and the antenna 32 corresponds to the “second antenna.”

### Vehicular Antenna Device 16 (Seventh Embodiment) and Vehicular Antenna Device 17 (Eighth Embodiment)

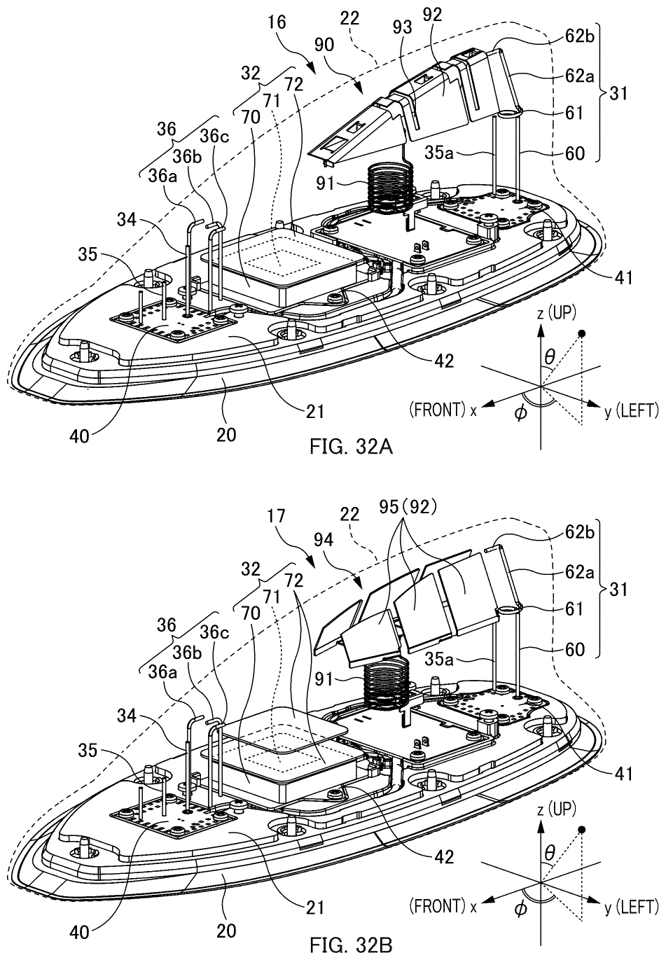

FIGS. 32A and 32B are perspective views of vehicular antenna devices 16 and 17, respectively. FIG. 32A is a perspective view of the vehicular antenna device 16, and FIG. 32B is a perspective view of the vehicular antenna device 17.

The vehicular antenna device 11 illustrated in FIG. 11, as mentioned above, includes an antenna 33 supporting radio waves in the DAB waveband. However, the vehicular antenna device 16 illustrated in FIG. 32A may include an antenna 90 supporting AM/FM radio waves instead of the antenna 33. The following describes the features of the vehicular antenna device 16 that are different from those of the vehicular antenna device 11.

The antenna 90 has a helical element 91 and a capacitively loaded element 92.

The helical element 91 is configured to resonate in the AM/FM radio frequency band together with the capacitively loaded element 92. The capacitively loaded element 92 is configured to resonate in the AM/FM radio frequency band together with the helical element 91. The capacitively loaded element 92 has slits 93 formed therein.

Additionally, as illustrated in FIG. 32B, the vehicular antenna device 17 includes an antenna 94 supporting AM/FM radio waves instead of the antenna 33 supporting radio waves in the DAB waveband, as with the vehicular antenna device 16. The antenna 94 includes a helical element 91, as in the antenna 90, and a capacitively loaded element 92 configured with multiple metal bodies 95.

The multiple metal bodies 95 have a structure in which the left and right sides thereof are electrically connected through the bottom, and those in the front and rear directions are connected through a structure such as a filter configured to electrically interrupt the operating frequency band of the antenna 32. Each segment constituting the metal body 95 is a flat or curved plate, but it can be changed in an appropriate shape, and may also have a meander shape. Moreover, at the apex portion or bottom, or anywhere in between, individual elements may be connected.

In the vehicular antenna devices 16 and 17, a parasitic element 35a is installed near the antenna 31, as illustrated in FIGS. 32A and 32B. This makes it possible to improve the directivity of the antenna 31 positioned in the rear.

In the vehicular antenna device 15 illustrated in FIG. 28B mentioned above, two antennas 32 are arranged vertically. Moreover, two parasitic elements 72 are arranged above the radiation element 71 of the antenna 32 in the upper stage. However, as illustrated in the vehicular antenna device 16 in FIG. 32A, a single antenna 32 may be arranged such that one parasitic element 72 is arranged above the radiation element 71. Furthermore, as illustrated in the vehicular antenna device 17 in FIG. 32B, a single antenna 32 may be arranged such that two parasitic elements 72 are arranged above the radiation element 71.

### Vehicular Antenna Device 18 (Ninth Embodiment) and Vehicular Antenna Device 19 (Tenth Embodiment)

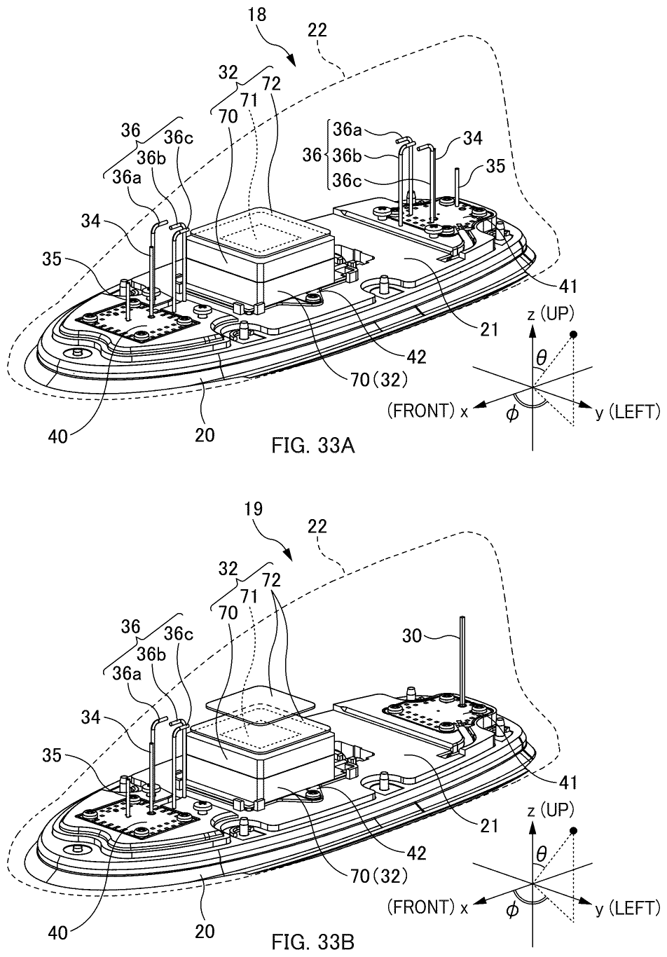

FIGS. 33A and 33B are perspective views of the vehicular antenna devices 18 and 19, respectively. FIG. 33A is a perspective view of the vehicular antenna device 18, and FIG. 33B is a perspective view of the vehicular antenna device 19.

In the vehicular antenna device 10 illustrated in the aforementioned FIG. 1, the antenna 30, which is a monopole antenna, is arranged in the front, and the antenna 31, which is a collinear antenna array, is arranged in the rear. In addition, in the vehicular antenna device 11 illustrated in the aforementioned FIG. 11, the antenna 34, which is a monopole antenna, and parasitic elements 35 and 36 are arranged in the front, and the antenna 31, which is a collinear antenna array, is arranged in the rear.

However, the antennas arranged in the front and the antennas arranged in the rear are not limited to the aforementioned cases. As illustrated in FIG. 33A, in the vehicular antenna device 18, the antennas 34, which are monopole antennas, and the parasitic elements 35 and 36 may be arranged in both the front and the rear. Further, as illustrated in FIG. 33B, in the vehicular antenna device 19, the antenna 34, which is a monopole antenna, and parasitic elements 35 and 36 may be arranged in the front, and the antenna 30, which is a monopole antenna, may be arranged in the rear. Furthermore, although not illustrated, it is not limited to the cases of the vehicular antenna devices 18 and 19 mentioned above, patch antennas may be arranged in both the front and the rear, for example.

In the vehicular antenna device 15 illustrated in FIG. 28B mentioned above, two antennas 32 are arranged vertically. Moreover, two parasitic elements 72 are arranged above the radiation element 71 of the antenna 32 in the upper stage. However, as illustrated in the vehicular antenna device 18 in FIG. 33A, two antennas 32 may be arranged vertically and one parasitic element 72 is arranged above the radiation element 71.

### Summary

The vehicular antenna devices 10 to 19 of embodiments of the present disclosure have been described above. For example, in the vehicular antenna device 14, the antenna 30 supporting radio waves in the V2X frequency band is provided at a position close to the case 22. Thus, the vehicular antenna device 14 can appropriately support radio waves in the desired frequency band (e.g., V2X radio waves).

In an embodiment of the present disclosure, in the vehicular antenna device 14, the antenna 30 is installed at a position separated, by a distance of substantially 75 mm or less (e.g., 5 mm), which is three-halves of one wavelength λ of the V2X frequency band, from the position at which the antenna 30 contacts the case 22. For example, as illustrated in FIGS. 5 and 7, by setting the position of the antenna 30 at the position separated, by a distance equal to or less than three-halves of one wavelength λ of the V2X frequency band, from the case 22, the directivity can be improved. As described above, in FIG. 7, the position at Db=90 mm corresponds to a position separated by 76 mm from the position at which the antenna 30 contacts the case 22.

In an embodiment of the present disclosure, in the vehicular antenna device 14, the antenna 30 is installed at a position separated by a distance of substantially 50 mm or less (e.g., 5 mm), which is one wavelength λ of the V2X frequency band, from the position at which the antenna 30 contacts the case 22. For example, as illustrated in FIGS. 5 and 7, by setting the position of the antenna 30 at the position separated, by a distance equal to or less than one wavelength λ of the V2X frequency band, from the case 22, the directivity can be further improved. As described above, in FIG. 7, the position at Db=64 mm corresponds to a position separated by 50 mm from the position at which the antenna 30 contacts the case 22.

In addition, for example, in the vehicular antenna device 10, each of the antennas 30 and 31 supporting radio waves in the V2X frequency band is provided at a position close to the case 22. Thus, the vehicular antenna device 10 can appropriately support radio waves in the desired frequency band (e.g., V2X radio waves).

Here, for example, it is also possible to provide a forward V2X-compatible antenna near the front windshield of a vehicle and to provide a rear V2X-compatible antenna in a shark-fin-type vehicular antenna device. However, such a configuration needs to connect a long transmission cable from the vicinity of the front windshield of the vehicle to the vehicular antenna device, for example. In embodiments of the present disclosure, antennas 30 and 31 with good directivity can be accommodated in the vehicular antenna device 10 with a simple configuration.

In addition, in an embodiment of the present disclosure, each of the antennas 30 and 31 is installed at a position separated by a distance of substantially 75 mm or less (e.g., 5 mm), which is three-halves of one wavelength λ of the V2X frequency band, from the position at which each of the antennas 30 and 31 contacts the case 22. For example, as illustrated in FIGS. 5 and 7, by setting the position of each of the antennas 30 and 31 at the position separated, by a distance equal to or less than three-halves of one wavelength λ of the V2X frequency band, from the case 22, the directivity can be improved. As described above, in FIG. 7, the position at Db=90 mm corresponds to a position separated by 76 mm from the position at which the antenna 30 contacts the case 22.

In addition, in an embodiment of the present disclosure, each of the antennas 30 and 31 is installed at a position separated by a distance of substantially 50 mm or less (e.g., 5 mm), which is one wavelength λ of the V2X frequency band, from the position at which each of the antennas 30 and 31 contacts the case 22. For example, as illustrated in FIGS. 5 and 7, by setting the position of each of the antennas 30 and 31 at the position separated, by a distance equal to or less than one wavelength λ of the V2X frequency band, from the case 22, the directivity can be further improved. As described above, in FIG. 7, the position at Db=64 mm corresponds to a position separated by 50 mm from the position at which the antenna 30 contacts the case 22.

Moreover, as illustrated in FIG. 10, for example, antennas 30 and 31 have different directions in which their gains increase, respectively. The vehicular antenna device 10 can receive a wider range of radio waves in the desired frequency band by using such antennas 30 and 31.

Furthermore, the antenna 30 is installed at the substrate 40 in the front of the metal base 21, and the antenna 31 is installed at the substrate 41 in the rear thereof. By arranging the antennas 30 and 31 apart from each other as such, it becomes possible to install additional antennas 32 and 33 between the antennas 30 and 31, thereby being able to suppress interference between the antennas.

Further, the antennas 32 and 33 supporting radio waves in a frequency band different from the V2X frequency band are provided between the antennas 30 and 31.

In addition, in an embodiment of the present disclosure, as illustrated in FIG. 8, the antenna 30 is arranged at a position at which the tip portion P1 of the front antenna 30 is separated rearward by a distance D1. Furthermore, as illustrated in FIG. 9, the antenna 31 is arranged at a position at which the end portion P2 of the linear portion 60 of the rear antenna 31 is separated forward by the distance D2. As such, by separating the front antenna 30 rearward and separating the rear antenna 31 forward from the case 22, the directivity of the vehicular antenna device 10 can be improved.

Moreover, the antenna 30 has a higher gain in the forward direction (+x direction), while the antenna 31 has a higher gain in the rearward direction (−x direction), and thus directions in which the gains for the antennas increases are different. The vehicular antenna device 10 can achieve near-ideal directivity (omni-directivity) in the desired frequency band with the use of such antennas 30 and 31.

Additionally, the case 22 has a so-called shark-fin shape, such that the front height thereof is lower than the rear height thereof. In accommodating two V2X antennas in such a case 22, in an embodiment of the present disclosure, the height of the front antenna 30 is set lower than the height of the rear antenna 31. By combining antennas having different heights and shapes as such, it is possible to improve the directivity of radio waves in the V2X frequency band.

In addition, in the vehicular antenna device 15, for example, as illustrated in FIG. 28B, the antenna 31 supporting radio waves in the V2X frequency band is accommodated in the accommodation space formed by the antenna base 20 and the case 22. Further, at least a portion of the antenna 31 is arranged at a position close to the case 22.

Furthermore, as illustrated in FIG. 28B, the vehicular antenna device 15 is accommodated in an accommodation space formed by the antenna base 20 and the case 22, and further includes an antenna 32 supporting GNSS band radio waves. Then, as illustrated in FIG. 29, the antenna 31 includes a circuit 63 configured to suppress the signals in the GNSS band supported by the antenna 32. This can mitigate the effects on the axial ratio performance of the antenna 32, which supports the GNSS band radio waves, and enables the antenna 31 to be arranged close to antenna 32.

At least the following matters will become apparent from the above descriptions of the specification and drawings.

An aspect of the present disclosure is a vehicular antenna device including a base, a case forming an accommodation space, with the base, a first antenna and a second antenna accommodated in the accommodation space, the first antenna supporting radio waves in the desired same frequency band, and a third antenna positioned between the first antenna and the second antenna, wherein at least a portion of the first antenna and at least a portion of the second antenna are arranged at a position close to the case.

In an embodiment of the present disclosures, the term “vehicular” means to be mountable to a vehicle. Thus, it is not limited to one mounted to a vehicle, but also includes one to be brought into a vehicle to be used in the vehicle. Further, it is assumed that the antenna device according to an embodiment of the present disclosure is used for a “vehicle” that is a vehicle provided with wheels, however, it is not limited thereto and, for example, the antenna device may be used for a movable body such as a flight vehicle including a drone and the like, a probe vehicle, a construction machinery, an agricultural machinery, a vessel, and the like without wheels.

Embodiments of the present disclosure described above are simply to facilitate understanding of the present disclosure and are not in any way to be construed as limiting the present disclosure. The present disclosure may variously be changed or altered without departing from its essential features and encompass equivalents thereof.

### REFERENCE SIGNS LIST

10 to 19 vehicular antenna device
20 antenna base
21, 500 metal base
22, 300, 400, 501 case
30 to 34, 37, 310, 410, 510 to 513, 90, 94 antenna
35, 35a, 36, 72 parasitic element
37a patch element
37b ground conductor plate
38 apex portion
39 inclined portion
40 to 42 substrate
43, 45, 48 screw
44, 46 coaxial cable
47 holder
49, 50 receiving portion
51, 52 cable accommodating portion
60, 62a linear portion
61 annular portion
62b bent portion
63 circuit
70 dielectric member
71 radiation element
80 holder
81, 91 helical element (coil)
82, 92 capacitively loaded element
93 slit
95 metal body
320, 420 ground plate
300a, 400a top surface
300b, 400b cylindrical member
P1, P3, P5 tip portion
P2 end portion
P4 corner portion

1. A vehicular antenna device comprising:
a base;
a case forming an accommodation space, with the base; and
a first antenna accommodated in the accommodation space, the first antenna supporting radio waves in a desired frequency band, wherein
at least a portion of the first antenna is arranged at a proximate position close to the case.

2. The vehicular antenna device according to claim 1, wherein
the proximate position is a position at which at least the portion of the first antenna is separated, by a predetermined distance in a horizontal direction, from a position at which at least the portion of the first antenna contacts the case, and
the predetermined distance is equal to or less than three-halves of a wavelength of the desired frequency band.

3. The vehicular antenna device according to claim 2, wherein
the predetermined distance is equal to or less than one wavelength of the desired frequency band.

4. The vehicular antenna device according to claim 1, further comprising:
a second antenna accommodated in the accommodation space, the second antenna supporting radio waves in the same frequency band as the desired frequency band; and
a third antenna positioned between the first antenna and the second antenna, wherein
at least a portion of the second antenna is arranged at a proximate position close to the case.

5. The vehicular antenna device according to claim 4, wherein
the proximate position is a position at which at least the portion of the first antenna and at least the portion of the second antenna are separated, by a predetermined distance in a horizontal direction, from a position at which at least the portion of the first antenna and at least the portion of the second antenna contacts the case, respectively, and
the predetermined distance is equal to or less than three-halves of a wavelength of the desired frequency band.

6. The vehicular antenna device according to claim 5, wherein
the predetermined distance is a distance equal to or less than one wavelength of the desired frequency band.

7. The vehicular antenna device according to claim 4, wherein
the first antenna and the second antenna are arranged in different directions in which gains increase, respectively.

8. The vehicular antenna device according to claim 4, further comprising:
a plurality of substrates at which the first antenna and the second antenna are arranged, the plurality of substrates being arranged at the base.

9. The vehicular antenna device according to claim 4, wherein
the third antenna supports radio waves in a frequency band different from the desired frequency band.

10. The vehicular antenna device according to claim 5, wherein
the proximate position at which at least the portion of the first antenna is close thereto is a first position separated, by the predetermined distance in a second direction opposite to the first direction, from a position of contact between the case on a first direction side of a predetermined axis in the horizontal direction and at least the portion of the first antenna, and
the proximate position at which at least the portion of the second antenna is close thereto is a second position separated, by the predetermined distance in the first direction, from a position of contact between the case on the second direction side and at least the portion of the second antenna.

11. The vehicular antenna device according to claim 10, wherein
the first antenna has a greater gain in the first direction out of gains in the first and second directions, and
the second antenna has a greater gain in the second direction out of the gains in the first and second directions.

12. The vehicular antenna device according to claim 10, wherein
a height of the first antenna from the base is lower than a height of the second antenna from the base, and
a height of the case from the base at the first position is lower than a height of the case from the base at the second position.

13. The vehicular antenna device according to claim 1, further comprising:
a second antenna accommodated in the accommodation space, the second antenna supporting radio waves in a frequency band different from the desired frequency band, wherein
the first antenna includes a circuit configured to suppress signals in the frequency band supported by the second antenna.
